(19) United States
(12) Patent Application Publication
(10) Pub. No.: US 2016/0322649 A1
(43) Pub. Date: Nov. 3, 2016

(54) ELECTROCHEMICAL CELLS AND COMPONENTS THEREOF

(71) Applicant: AQUAHYDREX PTY LTD, North Wollongong, New South Wales (AU)

(72) Inventors: Gerhard Frederick SWIEGERS, Woonona (AU); David John COX, Mount Ousley (AU); Deborah DE LA CRUZ, Vista, CA (US); Samuel DE LA CRUZ, Vista, CA (US); Steven Duwayne KLOOS, Naperville, IL (US); Paul Soo-Hock KHOO, Castle Hill (AU); Fletcher William THOMPSON, Coniston (AU); Andrew NATTESTAD, Fairy Meadow (AU); Dennis ANTIOHOS, Fairy Meadow (AU); Stephen Thomas BEIRNE, Farmborough Heights (AU)

(21) Appl. No.: 15/103,052

(22) PCT Filed: Dec. 10, 2014
(86) PCT No.: PCT/AU2014/050416

§ 371 Date: Jun. 9, 2016

(30) Foreign Application Priority Data
Dec. 10, 2013 (AU) 2013904802
Dec. 10, 2013 (AU) 2013904803
Dec. 10, 2013 (AU) 2013904804
Dec. 10, 2013 (AU) 2013904806
Dec. 10, 2013 (AU) 2013904807

(51) Int. Cl. H01M 8/00; H01M 8/0202; H01M 8/0232; H01M 4/86; C25B 11/03; H01M 8/2465; C25B 1/04; C25B 9/18; C25B 11/02; H01M 8/04082; H01M 4/88

(52) U.S. Cl. CPC H01M 8/004; H01M 8/04201; H01M 8/0202; H01M 8/0232; H01M 4/8605; H01M 4/8668; H01M 4/8807; H01M 4/8673; H01M 8/2465; C25B 1/04; C25B 9/18; C25B 11/02; C25B 11/035

(57) ABSTRACT

There is disclosed a spiral-wound electrochemical cell and components thereof, and aspiral-wound electrochemical cell for forming a chemical reaction product, comprising at least one electrode pair wound about a central axis. The present invention generally relates to configurations, arrangements or designs for gas, liquid and/or electrical conduits, pathways, connections, channels, arrangements or the like, in electro-chemical cells that are spiral-wound or have a spiral configuration, arrangement or design, and methods for their fabrication. More specifically, in various forms, the present invention relates to a core element, end cap(s), an external element containing or providing gas/liquid plumbing and/or electrical connections that provide improved functionality and reduced cost electro-chemical cells.

### TECHNICAL FIELD

The present invention relates to electrochemical cells, parts thereof, and to configurations, arrangements or designs for gas, liquid and/or electrical conduits, pathways, connections, channels, arrangements or the like, in electrochemical cells that are spiral-wound or have a spiral configuration, arrangement or design, and methods for their fabrication. More specifically, in various forms, the present invention relates to an external element, a core element and/or an end cap for spiral-wound electrochemical cells.

### BACKGROUND

Currently, numerous commercial or industrial electrochemical liquid-to-gas or gas-to-liquid reactions or transformations have various problems, for example high costs of materials, which force the use of high current densities in the: device or cell, with associated low overall energy efficiencies. For example, the electrochemical production of chlorine from brine (aqueous sodium chloride) is extremely wasteful of energy relative to just the energy that nature requires for oxidizing chloride to chlorine.

Many gas-to-liquid or liquid-to-gas processes are most effectively carried out by so-called Gas Diffusion Electrodes (GDEs). At the present time, commercially-available GDEs typically comprise fused, porous layers of conductive particles (usually carbon particles) of different size. The outer-most layers typically contain particles of the smallest dimensions, fused together with lesser amounts of PTFE (polytetrafluoroethylene, or Teflon™), a hydrophobic binder. The inner-most layers typically contain the largest particles. There may be multiple intermediate layers of intermediary particle size.

The intention of this gradation in particle size within GDEs, from largest in the center to smallest on the outer sides, is to create and control a solid-liquid-gas interface within the electrode. This interface should have the largest possible surface area. The creation of such an interface is achieved, effectively, by controlling the average pore sizes between the particles, ensuring that the smallest pore sizes are at the edges and the largest are in the center. Since the pores typically have some degree of hydrophobic character (often due to the use of hydrophobic PTFE as a binder), the small pore sizes at the edges (typically 30 microns pore size) act to hinder and limit the ingress of liquid electrolyte, for example water, into the GDE. That is, in the example case of water, unpressurized water typically penetrates only a relatively short distance into the GDE, where the electrochemically active surface area per unit volume, is largest. By contrast, the larger pores in the center of the GDE (e.g. 150 microns pore size), allow for ready gas transmission at low pressure along the length of the GDE, with the gas then forming a three-way solid-liquid-gas interface with the liquid water at the edges of the GDE, where the electrochemically active surface area per unit volume is the largest.

GDEs of this type often display significant technical problems during operation. These problems derive largely from the difficulty of creating a seamlessly homogeneous particulate bed, with uniformly dispersed pore sizes and distributions, and uniform hydrophobicity (imparted by the hydrophobic PTFE (polytetrafluoroethylene, or Teflon™) binder within the GDE).

Other problems associated with electrochemical cells, modules or reactors that utilise GDEs relate to a need for more convenient and/or efficient pathways within the cell, module or reactor to separately plumb, transport or transfer the gas(es) and/or liquid reactants, products, and electrolyte(s), and to fit or accommodate the electrical connections.

A key challenge in this respect is to devise gaseous, fluidic and electrical conduits, pathways, connections, channels, arrangements or the like, that are:
(1) readily fabricated
(2) relatively low-cost,
(3) reliable in operation (that is, they are generally resistant to leaks in the case of the liquid and gas channels, and to electrical shorting in the case of the electrical circuits).
(4) relatively easily assembled, and/or
(5) functionally synergistic with other components (that is, they facilitate and do not obstruct or impair the functionality of other module components).

There is an ongoing need for new and improved solutions in this respect.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Examples. This Summary is not intended to identify all of the key features or essential features of the claimed subject matter, nor is it intended to be used to limit the scope of the claimed subject matter.

In various aspects there is provided: an electrochemical cell; an element, a component or a part of an electrochemical cell, such as gaseous, fluidic and/or electrical conduits, pathways, connections, channels, arrangements or the like for electrochemical cells; electrodes and configurations of electrodes, such as leafs, that are or are able to be spiral-wound; and/or electrochemical cells, modules or reactors that are spiral-wound or have a spiral configuration, arrangement or design.

In one aspect there is provided a spiral-wound electrochemical cell for forming a chemical reaction product, comprising at least one electrode pair wound about a central axis. Preferably, the at least one electrode pair is an anode and a cathode.

In another example, the anode is gas permeable and liquid impermeable; and/or the cathode is as permeable and liquid impermeable. Preferably, the electrochemical cell is art electro-synthetic cell (i.e. a commercial cell having industrial application) or an electro-energy cell (e.g. a fuel cell). In another example, the cell utilizes abiological manufactured components or materials, for example polymeric materials, metallic materials, etc. In another example, the cell utilizes only, or wholly, abiological manufactured components or materials. In another example, there is provided an inter-electrode channel between the anode and the cathode for gas and/or fluid transport. Optionally, there is provided two anodes and an anode channel between the two anodes for gas and/or fluid transport. Also optionally, there is provided two cathodes and a cathode channel between the two cathodes for gas and/or fluid transport. In another example, the channel is at least partially formed by at least one spacer. In another example, there is provided at least two anodes and at least one anode channel, and at least two cathodes and at least one cathode channel.

In one example aspect, there is provided a spiral-wound electrochemical cell, module or reactor having a core element, around which one or more electrodes (e.g., at least one electrode pair provided by an anode or a cathode) are wound in a spiral fashion. The at least one electrode pair can form part of a multi-electrode array, which can be considered as being comprised of a series of flat flexible anodes and cathodes that can be wound in a spiral fashion. A “leaf” is comprised of one or more electrodes, for example an electrode, a pair of electrodes, a plurality of electrodes, or some other form of electrode unit. A leaf is flexible and can be repeated as a unit.

For example, a leaf can include in part, or be formed by:

one or a single electrode, for example a single cathode or a single anode;

a single sheet of electrode material that is folded or two sheets that are connected to provide two electrodes, for example two cathodes or two anodes;

two electrodes, for example two cathodes or two anodes;

an electrode pair, for example an anode and a cathode; or

a plurality of any of the above.

In another example, a leaf can include in part, or be formed by, two electrode material layers (with both layers together for use as an anode or a cathode) that are positioned on opposite sides of an electrode channel spacer (i.e. a spacer material, layer or sheet, which for example can be made of a porous polymeric material) which provides a gas and/or liquid channel between the two electrodes.

In another example, a leaf can include in part, or be formed by, two electrode material layers (with one electrode material layer for use as an anode and one electrode material layer for use as a cathode) that are positioned on opposite sides of an inter-electrode channel spacer (i.e. a spacer material, layer or sheet, which for example can be made of a porous polymeric material) which provides a gas and/or liquid channel between the two electrodes (i.e. between the anode and the cathode).

In another example, a leaf can include in part, or be formed by, a single electrode material layer (for use as an anode or as a cathode). In another example, the electrode material layer can be positioned adjacent a channel spacer (i.e. a spacer material, layer or sheet, which for example can be made of a porous polymeric material) which provides a gas and/or liquid channel.

Repeated leafs provide a multi-electrode array being a series of spiral-wound electrodes with intervening spacers providing separated gas and/or liquid channels. The electrode channel spacer can be a different, or in one example the same, material as the inter-electrode spacer. The electrochemical cell, module or reactor may optionally also involve end caps, and one or more external elements.

In one example aspect, gaseous, fluidic and/or electrical conduits, pathways, connections, channels, arrangements are routed through the core clement. In another example aspect, gaseous, fluidic and/or electrical conduits, pathways, connections, channels, arrangements are routed through the end caps. In another example aspect, gaseous, fluidic and/or electrical conduits, pathways, connections, channels, arrangements are routed through the external elements.

In further example aspects, the gaseous and/or fluidic pathways, connections, channels, arrangements are routed through one or more of the core element, the end cap or caps, and/or one or more of the external elements, whilst the electrical conduits, pathways, connections, channels, arrangements are routed through another of, i.e., a different one of, the core element, the end cap or caps, and/or one or more of the external elements.

In still further example aspects, the gaseous and/or pathways, connections, channels, arrangements are routed through a single one of the core element, the end cap or caps, or the external elements, whilst the electrical conduits, pathways, connections, channels, arrangements are routed through a single one of the core element, the end cap or caps, or the external elements.

Preferably but not exclusively, the core element, the end caps, and/or the external elements are configured to provide for improved or efficient functionality of one or more components in the cell and of the cell itself.

Preferably but not exclusively, the core element, the end caps, and/or the external elements are configured to provide for simple, quick, and inexpensive assembly of components in the cell and of the cell itself.

Preferably but not exclusively, the core element, end caps, and/or external elements are low-cost and readily fabricated from commonly available and inexpensive materials, such as polymeric materials, using inexpensive fabrication techniques, such as injection moulding or extrusion.

In another aspect, there is provided convenient and efficient configurations, arrangements, or designs for the liquid/gas plumbing of spiral-wound electrochemical cells, modules or reactors, that incorporate a flexible leaf of a single electrode, two electrodes, electrode pair (i.e. cathode and anode pair), or multi-electrodes, and where the flexible leaf may include a sealed gas/liquid channel, either associated with a single electrode, between two electrodes, and/or between an electrode pair. A leaf is a repeatable unit. For example, a leaf providing a repeatable unit can be two or more electrodes, (e.g. two or more anodes, two or more cathodes, or two or more pairs of cathodes and anodes) and can form part of a multi-electrode array. Preferably, the leaf also includes at least one gas or liquid channel, which can be sealed or partially sealed to provide exit and/or entry regions, for example for one or more reactants, one or more products, and/or one or More electrolytes.

In one example embodiment there is provided a convenient and efficient configuration, arrangement, or design for gas/liquid plumbing of spiral-wound electrochemical cells, modules or reactors, such that the core element, end caps, and/or external elements is/are fabricated to incorporate at least one conduit suitable for transporting gas or liquid down its/their length for a flexible leaf, and where the flexible leaf comprises of a sealed, or partially sealed, gas/liquid channel with its associated electrode or electrodes.

In another example embodiment there is provided a core element, end caps, and/or external elements for a spiral-wound electrochemical cell, the core element, end caps, and/or external elements comprising: at least one conduit suitable for transporting gas or liquid provided along the core element, end caps, or external elements; and, an aperture or series of apertures provided along the core element, end caps, or external elements and associated with the at least one conduit; wherein, the aperture or series of apertures is able to receive an end from, or part of an end from, or gas from, or liquid from a flexible electrode, where the flexible electrode is able to be spiral-wound about the core element. In another embodiment, the aperture or series of apertures is able to provide a lip to, or part of a lip to, or gas to, or liquid to a flexible electrode, where the flexible electrode, or leaf, is able to be spiral-wound about the core element.

In another example embodiment, an electrolyte is provided between, or within, the leafs and enters the spiral-wound electrochemical cell from an axial end (distal end of a spiral along the longitudinal axis) and optionally may be able to enter or exit the cell or module from both axial ends and optionally flow from one axial end to the other axial end.

In another example embodiment, an electrolyte is provided between, or within, the leafs and enters the spiral-wound electrochemical cell from either the core element or from an axial end, e.g. from the direction of the outermost ends of the leafs at the center of the spiral or the end of the spiral. In another example the electrolyte may be able to enter or exit the cell or module from both axial ends and optionally flow from one axial end to the other axial end.

In another example embodiment, the cathode or anode product(s) exits the spiral-wound electrochemical cell via the leaf at either one or both of the axial ends of the leaf. In further example embodiments, the cathode or anode reactant(s) enters the spiral-wound electrochemical cell via the leaf at either one or both of the axial ends of the leaf. In other example embodiments, the reaction product exits the spiral-wound electrochemical cell from either the central core element or from the outermost axial ends of the leafs.

In one preferred embodiment, an electrolyte enters and exits from the axial ends and the reaction product(s) exits the spiral-wound electrochemical cell via or from the central core element (i.e. via axial end or ends).

Various aspects of the invention also extend to systems, configurations and/or methods for forming the gas/liquid plumbing connections between a leaf or leafs and the liquid/gas conduit or conduits, so as to thereby appropriately bring together, group, or aggregate liquid/gas channels in the leaf and/or like leafs into single gas/liquid fittings.

These are preferably but not exclusively achieved by one or more of the example arrangements discussed below:

(1) Liquid/Gas Plumbing through the Core Element:
i. “Conduit and Central Unit Assembly”: In one example, the conduit is fabricated as part of a stand-alone unit, to which a leaf may be sealed, glued, welded, potted or otherwise attached in such a way that the aperture/s of the conduit is/are in fluid communication with the gas/liquid channels within the leaf. The stand-alone conduit unit with its attached leaf, may then be sealed, glued, welded, or otherwise attached to a separate central unit, to thereby create the core element (with the leaf attached). The core element is therefore created by the assembly of the stand-alone, conduit unit (with its attached leaf) and the central unit. Alternatively, the leaf may be sealed, glued, welded, or otherwise attached to the central unit which is then sealed, glued, welded, or otherwise attached to the conduit unit. A third alternative is that the leaf may be sealed, glued, welded, or otherwise attached to both the conduit unit and the central unit at the time that they are scaled, glued, welded, or otherwise attached to each other. The common feature of all of these approaches is that the core element is created by the assembly of the stand-alone conduit unit and the central unit, with the leaf attached prior to or at the time that the core element is created.
ii. “Direct Attachment”: In another example, the core element is fabricated as a single cylindrical or cylinder-like unit containing at least one conduit or proto-conduit, to which its leaf or leafs may be scaled, glued, welded, potted or otherwise attached in such a way that the aperture/s of the at least one conduit in the core element is/are in fluid communication with the gas/liquid channels within the leaf associated with that conduit.
iii.“Conduit Unit Assembly”: In a still further example, the conduit is fabricated within a stand-alone unit, to which the leaf is sealed, glued, welded, potted, or otherwise attached in such a way that the aperture/s of the conduit is/are in fluid communication with the gas/liquid channels within the leaf. One or more conduit units, with their attached leafs are then sealed, glued, welded, potted or otherwise attached together, to thereby create the core element out of the combined stand-alone conduit units (each of which has their leaf attached). This method differs from the Conduit and Central Unit Assembly method only in the absence of a central unit.

(2) Liquid/Gas Plumbing through the End Cap or at a Axial End of the Spiral-Wound Module:
i. “End-Cap Conduit”: In one example, the conduit is fabricated within an end-cap and the conduit is then plumbed to a lead or leafs. This may occur via a single or multiple plumbing connections between the end cap and the leaf/s. Alternatively, it may involve a continuous plumbing attachment between the end cap and the leaf/s. For example, the conduit may be incorporated as a spiral shaped groove within a spiral-shaped end-cap. A leaf is fed along the groove until the leaf fills the entire groove. The leaf and spiral-shaped end cap are then sealed, glued, welded, potted or otherwise attached to each other in such a way that the conduit formed by the spiral-shaped groove is in fluid communication with the gas/liquid channels within the leaf.
ii. “Axial” Plumbing: In another example, the end-caps are porous or there are no end caps present, so as to thereby permit the free flow of gas/liquid through to the spiral-wound flexible electrode in a direction perpendicular to the direction of spiral winding. In this way, an anode, cathode or inter-electrode channel within a spiral-wound multi-electrode array may be sealed to the core element and any external element, but may be open to axial flow in a direction perpendicular to the spiral-winding of the leafs. Such axial flow may optionally be through, a porous end cap. The liquid or gas may enter or exit the module from both axial ends and optionally flow from one axial end to another.

(3) External Liquid/Gas Plumbing:
“External Conduit”: In one example, the conduit is fabricated as part of a stand-alone unit, to which a leaf is sealed, glued, welded, potted or otherwise attached in such a way that the aperture/s of the conduit is/are in fluid communication with the gas/liquid channels within the leaf. The leaf is then spiral-wound around its other end, leaving the conduit on the outside of, and external to the spiral-wound assembly.

In a further example embodiment, there is provided a convenient and efficient configuration, arrangement, or design for electrically connecting a flexible leaf, i.e. a multi-electrode array, within a spiral-wound electrochemical cell, module or reactor, and where the flexible leaf comprises of a sealed gas/liquid channel with its associated electrode or electrodes.

In one example embodiment there is provided a core element, end caps, and/or external elements for a spiral-wound electrochemical cell, the core element, end caps, and/or external elements comprising: at least one conduit containing an electrically conductive element, such as a (primary) busbar, provided along the core element, end caps, or external elements; and, an aperture or series of apertures provided along the core element, end caps, or external elements and associated with the at least one conduit containing the electrically conductive element; wherein, the aperture or series of apertures is able to receive a conductive end from, or part of a conductive end from, or an electrode from, or a (secondary) busbar from a flexible electrode, where the flexible electrode is able to be spiral-wound about the core element. In another embodiment, the aperture or series of apertures is able to provide a conductive lip to, or part of a conductive lip to, or an electrode to, or a (secondary) busbar to a flexible electrode, where the flexible electrode is able to be spiral-wound about the core element.

In alternative embodiments there is provided a core element, end caps, and/or external elements for a spiral-wound electrochemical cell, the core element, end caps, and/or external elements comprising or containing an electrically conductive element, such as a (primary) busbar, provided along the core element, end caps, or external elements; and wherein, the conductive element is able to receive a conductive end from, or part of a conductive end from, or an electrode from, or a (secondary) busbar from a flexible electrode, where the flexible electrode is able to be spiral-wound about the core element. In another embodiment, the conductive element is able to provide a conductive lip to, or part of a conductive lip to, or an electrode to, or a (secondary) busbar to a flexible electrode, where the flexible electrode is able to be spiral-wound about the core element.

In other example aspects there are provided methods for forming the electrical connections with the flexible electrode leaf so as to thereby appropriately bring together, group, or aggregate electrodes in the leaf into single electrical fittings. These are preferably, but not exclusively, achieved by one of the means described below:

(1) Electrical Connection through an End-Cap:
i. “Axial Attachment”: In an example, the electrode, of the flexible leaf is directly welded, soldered, glued with conductive glue, or otherwise attached in conductive electrical contact to a primary busbar located at or in place of an end cap.
ii.“Axial Busbar Attachment”: In another example, the electrode in the flexible leaf is welded, soldered, glued with conductive glue, or otherwise attached in conductive electrical contact to a secondary busbar, which is disposed across the flexible electrode, perpendicular to the direction of spiral-winding. The unattached end of the secondary busbar is further welded, soldered, glued with conductive glue, or otherwise attached in conductive electrical contact to a primary busbar located at or in place, of an end cap.

(2) Electrical Connection through the Core Element:
i. “Internal Spiral Attachment”: In one example the electrode of the flexible leaf is directly welded, soldered, glued with conductive glue, or otherwise attached in conductive electrical contact to a primary busbar located at, and running down all or part of the length of the core element. The primary busbar may be located within the care element, or it may be attached to the outside of the core element.
ii. “Internal Spiral Busbar”: In another example, the flexible electrode leaf is welded, soldered, glued with conductive glue, or otherwise attached in conductive electrical contact to a secondary busbar, which is disposed across the flexible electrode, in the direction of spiral-winding. The unattached end of the secondary busbar is then welded, soldered or otherwise electrically attached to a primary busbar located at, and running down all or part of the length of the core element. The primary busbar may be located within the core element, or it may be attached to the outside of the core element.

(3) External Electrical Connection:
i. “External Spiral Attachment”: In one example the electrode of the flexible leaf is directly welded, soldered, glued with conductive glue, or otherwise attached in conductive electrical contact to a primary busbar located at, and running down part or all of the length of the external element. The primary busbar may be located within the external element, or it may be attached to the outside of the external element.
ii.“External Spiral Flasher Attachment”: In another example, the flexible electrode leaf is welded, soldered, glued with conductive glue, or otherwise attached in conductive electrical contact to a secondary busbar, which is disposed across the flexible electrode, in the direction of spiral-winding. The unattached end of the secondary busbar is then welded, soldered, glued with conductive glue, or otherwise attached in conductive, electrical contact to a primary busbar located at, and running down all or part of the length of the external element. The primary busbar may be located within the external element, or it may be attached to the outside of the external element.

Other methods or arrangements can be used for electrical connection of the flexible electrode leafs through the core element, end caps, and/or external elements. Preferably but not exclusively, one or more of the above arrangements or methods for forming the gas/liquid plumbing can be combined with one or more of the above arrangements or methods for forming the electrical connections when fabricating electrochemical cells, modules or reactors that are spiral-wound or have a spiral configuration, arrangement or design. It is to be understood that, without limitation, all combinations, permutations, or arrangements can be utilised in which one or more of the above arrangements or methods of gas/liquid plumbing are used together with one or more of the above arrangements or methods of electrical connection to create a spiral-wound cell.

Moreover, it is to be understood that it is not necessarily the case that the components of a spiral-wound cell are individually formed or provided as a core element, end cap or external element. In some example cases, components may carry out functions that are a hybrid of two or more of the functions of the described core element, end cap or external element. For example, an end cap(s) may be integrally formed as part of the core clement or the external clement. In other example cases, a component may be either an external element or an end cap, or neither. In these cases, it is to be understood that all combinations, permutations or arrangements in which one or more of the above arrangements or methods of gas/liquid plumbing and/or one or more of the above arrangements or methods of electrical connection to create a spiral-wound cell, fall within the scope of the present invention regardless of whether or not the specific components involved can be clearly identified as belonging to a particular class of element.

It is further to be understood that not all classes or types of element are required in a spiral-wound electrochemical cell, module or reactor. For example, end caps or an external element may not be needed. Similarly, a core element may not be required.

In some embodiments, multiple leafs may be plumbed to the core element, the end cap or caps, arid/or the external elements. In some embodiments, multiple leafs may be placed in electrical contact with the core element, the end caps, and/or the external elements. In such examples, the core element, the end caps, and/or the external elements are preferably, but not exclusively, designed so as to bring together the accumulated plumbing and electrical systems into a single set of external connections for each of the plumbed gases/liquid lines and each of the electrical fittings.

Preferably but not exclusively, once the gas/liquid plumbing and the electrical attachments are secured, the flexible leafs of the electrochemical cell, module or reactor can be rolled into a spiral-wound arrangement, with suitable spacers (e.g. one or more porous polymeric sheets of material) applied between the different electrodes, and leafs if more than one leaf, to thereby avoid short-circuits forming between the electrodes of different leafs used as cathodes or anodes.

The spiral-wound electrochemical cell, module or reactor, with one or more leafs attached and with secure plumbing and electrical connections, then can be, preferably but not exclusively, encased in a case or housing, preferably a tight fitting polymer case, and equipped with end caps of the type described earlier. The end caps may be stand-alone units, or they may comprise part of the case or housing, or there may be a stand-alone end cap and an outer end cap that is part of the case or housing.

### BRIEF DESCRIPTION OF THE DRAWINGS

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1(a) depicts components of an example spiral-wound electrochemical cell, module or reactor in a partially wound and constructed state, namely: the core element, the end-caps, the external element(s), and the multi-electrode array formed of leafs; FIG. 1(b) depicts the example spiral-wound electrochemical cell, module or reactor in a fully wound state; FIG, 1(c) depicts an example arrangement for the multi-electrode array comprised of example leafs. The number of electrodes shown is provided by way of example only. FIGS. 1(d)-(j) schematically depicts various examples of leafs that may be spiral-wound.

FIG. 2 schematically depicts an example multi-electrode arrangement as an array of electrodes, formed at least partially of flexible leafs, which can be rolled in a spiral manner, in which the anode channels have been plumbed into (i.e. are open to, are in gaseous communication with, or are in fluid communication with) the core element, the cathode channels have been plumbed into are open to, are in gaseous communication with, or are in fluid communication with) the external element, and the inter-electrode channels are sealed from both the core clement and the external element but are open in (i,e. are in gaseous communication with or are in fluid communication with) the direction perpendicular to the length of the leaf (axial direction when rolled) toward the end caps (not illustrated). The number of electrodes shown is provided by way of example only and the core/external elements are not to scale with the electrodes (for clarity).

FIGS. 3(a), 3(b) and 3(c) schematically depict example useful approaches when plumbing one or more flexible leafs through the core element.

FIG. 4(a) schematically depicts the Axial Electrical Attachment example method and FIG. 4(b) schematically depicts the Spiral Electrical Attachment example method, for electrically connecting electrodes in a flexible leaf with a conductive element (‘primary busbar’) in an end cap.

FIG. 5(a) schematically depicts the Axial Busbar Attachment example method and FIG. 5(b) schematically depict the Spiral Busbar Attachment example method, for electrically connecting electrodes in a flexible leaf with a conductive element (‘primary busbar’) in an end cap.

FIGS. 6(a) and 6(b) schematically depict an example spiral-wound cell or module, (a) before winding of leafs, (b) after winding, in which the electrical connections are made asymmetrically, through the end-caps.

FIG. 7 depicts: (a) an example Profile Needle and (b and c) the process of gluing two flexible electrodes (both either anodes or cathodes) with axial busbars to the electrodes, whilst creating a liquid/gas collecting channel between the two electrodes.

FIG. 8 depicts how: (a) example Conduit Units (Profile Needles) are assembled with the hexagonally-shaped Central Unit using the ‘Conduit and Central Assembly’ method, both: (b) before and (c) after flexible electrode leafs are attached to the Profile Needles.

FIG. 9 depicts how (a) the example Conduit Units (Profile Needles) are assembled with the hexagonally-shaped Central Unit using the ‘Conduit and Central Assembly’ method, and how the primary hushes are introduced in the two end caps. The free ends of the axial busbars are welded to the primary busbars to create the electrical connections. The final assembly is shown at (b). The leafs are spiral-wound around the core clement but are not depicted in the bottom picture (b) for clarity.

FIG. 10 depicts (a)-(b) an example spiral-wound module fabricated using the Profile Needle Design and the Conduit and Central Assembly method, after it has been encased in a polymeric casing.

FIG. 11 depicts an exploded view of the different components (but not the flexible leafs) of example spiral-wound modules assembled using the Profile Needle design, where two modules have further been assembled into a linear array.

FIGS. 12(a) to 12(c) depict the Glued Wedge design applied to a Conduit and Central Unit Assembly method.

FIGS. 13(a) to 13(c) schematically depict a Tricot Pack design applied to a Direct Attachment Method of assembly.

FIGS. 14(a) and 14(b) schematically depict a Syringe Needle design applied to a Conduit Unit Assembly Method.

FIG. 15 schematically depicts a Rolodex design applied to a Conduit Unit Assembly Method.

FIG. 16 illustrates an example core element suitable for gas/liquid plumbing through the core element.

FIG. 17 schematically illustrates a cross-section of an example 2-leaf core clement for a Wedge Glue design.

FIG. 18 schematically illustrates a cross-section of an example 8-leaf core element for a Wedge Glue design.

FIG. 19 schematically illustrates the connections between the leafs and the 8-leaf core element in cross-section for the Wedge Glue design of FIG. 18.

FIG. 20 schematically illustrates an example 4-leaf spiral-wound module employing the Wedge Glue design for plumbing of the core element.

FIG. 21 depicts a close-up, perspective (cross-sectional) view of the external aperture of a conduit in the 4-leaf core element of FIG. 20, showing the connections (in the absence of the gluing resins for clarity).

FIG. 22 depicts the conduit in FIG. 21 in enlarged cross-sectional view.

FIG. 23 schematically illustrates (a) and (c) cross-sectional views, and (b) and (d) perspective views, respectively, of an example 2-leaf core element for a Potted Plumbed design.

FIG. 24 schematically illustrates (a) a cross-sectional view and (b) a perspective view of an example core element for a 2-Leaf Conductive Potted Plumbed design.

FIG. 25 schematically illustrates (a) a cross-sectional view and (b) a perspective view of an example core element for a 4-Leaf Conductive Potted Plumbed design.

### EXAMPLES

The following modes, features or aspects, given by way of example only, are described in order to provide a more precise understanding of the subject matter of a preferred embodiment or embodiments.

International Patent Application No. PCT/AU2013/000617 for “Gas Permeable Electrodes and Electrochemical Cells” filed 11 Jun. 2013, is incorporated herein by reference, and describes gas diffusion electrodes, and aspects thereof, that can be spiral-wound and utilised in the present examples.

Further aspects and details of example electrodes that can be utilised in the present examples am described in the Applicant's previously filed International Patent Application No. PCT/AU2014/050161 for “Modular Electrochemical Cells” filed 30 Jul. 2014, the Applicant's previously filed International Patent Application No. PCT/AU2014/050160 for “Composite Three-Dimensional Electrodes and Methods of Fabrication” filed 30 Jul. 2014, the Applicant's previously filed international Patent Application No. PCT/AU2014/050162 for “Electro-Synthetic or Electro-Energy Cell With Gas Diffusion Electrode(s)” filed on 30 Jul. 2014, and the Applicant's previously filed International Patent Application No. PCT/AU2014/050158 for “Method and Electrochemical Cell for Managing Electrochemical Reactions” filed on 30 Jul. 2014, which are all incorporated herein by reference.

### A. Example Components of Spiral-Wound Modules

### A.1. Example Components of Spiral-Wound Modules—Core Element, End Caps, and External Elements

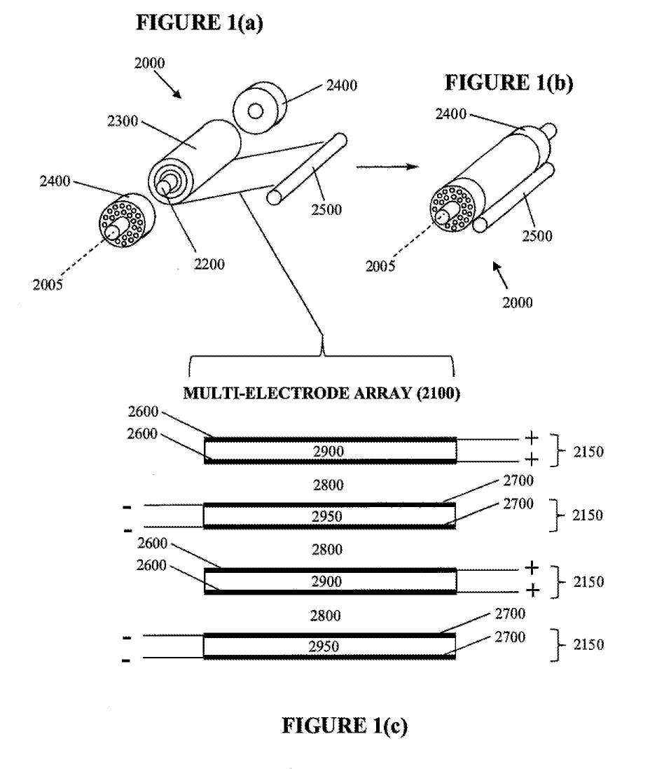

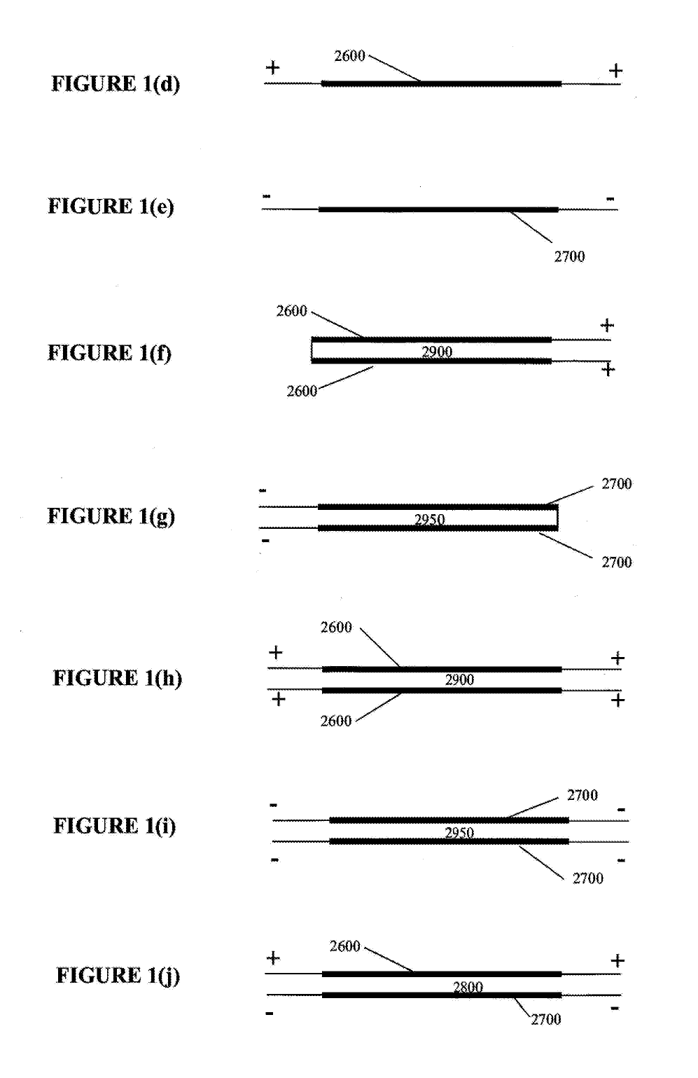

FIGS. 1(a), 1(b) and 1(c) schematically illustrate components of example spiral-wound electrochemical cells, modules or reactors 2000. FIG. 1(a) depicts components of an example spiral-wound electrochemical cell, module or reactor 2000 in a partially wound and constructed state, namely: the core element 2200, the end-caps 2400, the external element 2500, and the mold-electrode array 2100 formed of leafs 2150 which wound about a central axis 2005. FIG. 1(b) depicts the example spiral-wound electrochemical cell, module or reactor 2000 in a fully wound state about central axis 2005. FIG. 1(c) depicts an example arrangement for the multi-electrode array 2100, including leafs 2150. The number of electrodes and channels (i.e. anodes 2600 and cathodes 2700) shown is provided by way of example only and can vary depending on the implementation desired. At least one electrode pair is provided by an anode 2600 and an adjacent or opposing cathode 2700. The spiral-wound cells, modules or reactors 2000 typically involve flexible electrode sheets 2600, 2700 stacked in two or more layers, i.e. a multi-electrode array 2100, where an anode 2600 and cathode 2700 adjacent pair are separated from one another by distinctive “Inter-Electrode Channel” spacers (not illustrated for clarity) which are electrically insulating and provide an inter-electrode channel 2800 (which, in some embodiments, are permeable to, and intended to guide the permeation of liquid electrolyte through the cell 2000) and/or “Anode Channel” spacers or “Cathode Channel” spacers (i.e. electrode channel spacers) (not illustrated for clarity) which provide an anode channel 2900 of a leaf 2150 and a cathode channel 2950 of a leaf 2150 (which, in some embodiments, are permeable to and intended to guide the permeation of gases/liquids through the cell 2000). The inter-electrode channels and/or the electrode channels can be formed by one or more layers of porous polymeric material, for example provided as sheets of porous polymeric material or sheets of different types of porous polymeric materials. Some or all of the different types of channels 2800, 2900, 2950 may be plumbed, i.e. placed in fluid communication and/or gas communication, in the cell or module 2000. For example, all of the cathode channels 2950, associated with and collecting products front or providing reactants to the cathodes 2700 may be plumbed together into a single inlet/outlet. Similarly, all of the anode channels 2900, associated with and collecting products from or supplying reactants to the anodes 2600, may be plumbed together into a separate single inlet/outlet. Thus, for example, there may be two distinct gas channels, one for a first gas (e.g. hydrogen produced at the cathode in a water electrolysis cell) and another for a second gas (e.g. oxygen produced at the anode in a water electrolysis cell). In other embodiments, the inter-electrode channels 2800 may be plumbed so as to feed liquid electrolyte between the anodes 2600 and cathodes 2700, but not the anode channels 2900 or cathode channels 2950 that can be left open to the air (or other gas or vacuum or partial vacuum). In still other embodiments, one type of channel may be plumbed for a liquid (e.g. the inter-electrode channels 2800 may be plumbed to carry liquid HCl electrolyte), while a second channel may be plumbed to carry a gas (e.g. the cathode channel 2950 may be plumbed to carry oxygen). The third channel may then be left open for collection of a product (e.g. the anode channels 2900 may be left open to collect chlorine gas in an oxygen-depolarised chlor-alkali cell). A repeatable unit of electrodes 2600, 2700 with their associated, sealed gas-liquid channels 2900, 2950 is referred to herein as a leaf 2150 in the multi-electrode array 2100.

The resulting multi-electrode array 2100 is wound, to form a spiral-wound electrode structure 2300, about a core element 2200, to thereby create the spiral-wound cell or module 2000. The core element 2200 may contain some or all of the gas-liquid and electrical conduits with which to plumb and/or electrically connect the various components of the cell or module 2000. For example, the core element 2200 may combine all of the channels for one or another particular gas in the multi-electrode array 2100 into a single pipe, which is then conveniently valved for attachment to an external gas tank. The core element 2200 may similarly contain an electrical arrangement which connects the anodes and cathodes of the module into only two external electrical connections on the module—a positive pole and a negative pole.

The tightly-wound multi-electrode array 2100 is further typically affixed to end caps 2400 that may also serve to combine all of the channels for one or another particular gas in the array into a single pipe, which is then conveniently valved for attachment to an external gas tank. The end caps 2400 may similarly contain an electrical arrangement which, connects the anodes and cathodes of the module into only two external electrical connections on the module—a positive pole and a negative pole. Finally, the multi -electrode array 2100 may be attached at its outer radial end to an external element 2500, through which the various channels may be plumbed and electrical connections made.

The key advantage of spiral-wound cells or modules over other module arrangements is considered to be that they provide a high overall electrochemical surface area within a relatively small overall geometric footprint. A spiral-wound electrochemical module is believed to provide for the highest possible active surface area within the smallest reasonable footprint. Another advantage of spiral-wound arrangements is that round objects are easier to pressurize than other geometries which involve flat areas and corners. So, the spiral design has been found to be beneficial for a water electrolyser cell, which converts water into hydrogen and oxygen, and for a fuel cell, which converts hydrogen and oxygen into water, because the spiral-wound cell enables the opportunity to directly pressurize the reactor in an easy to manufacture, low-cost format.

The inventors have created a number of convenient methods, arrangements, structures and designs for arranging, the gas/liquid plumbing and the electrical connections so as to thereby simplify the fabrication and assembly of spiral-wound cells of this type. These approaches and designs for exploiting them in the fabrication of spiral-wound cells are described below. In particular examples, the electrochemical cell utilizes abiological components, preferably abiological manufactured components, and could use only abiological components or materials. For example, the materials of the leafs are abiological materials.

Thus, in a general embodiment there is provided a spiral-wound electrochemical cell 2000 for forming a chemical reaction product, comprising at least one electrode pair (anode 2600 and cathode 2700) wound about a central axis 2005. Preferably, the anode 2600 is gas permeable and liquid impermeable and/or the cathode 2700 is gas permeable and liquid impermeable. The electrochemical cell 2000 is preferably an electro-synthetic cell (i.e. a commercial cell having industrial application) or an electro-energy cell (e.g. a fuel cell). Preferably, the cell utilizes abiological manufactured components.

In one example, an inter-electrode channel 2800 is provided between an anode 2600 and an adjacent or opposing cathode 2700 for gas and/or fluid transport. Optionally, there are two anodes 2600 and an anode channel 2900 provided between the two anodes 2600 for gas and/or fluid transport. Also optionally, there are two cathodes 2700 and a cathode channel 2950 provided between the two cathodes 2700 for gas and/or fluid transport. In another example, the channel 2800, 2900, 2950 is at least partially formed by at least one spacer.

In another example, there is provided at least two anodes 2600 and at least one anode channel 2900, and at least two cathodes 2700 and at least one cathode channel 2950. Optionally, the chemical reaction product is transported through the channel (anode channel 2900, cathode channel 2950 or inter-electrode channel 2800). Optionally, a chemical reactant is transported through the channel (anode channel 2900, cathode channel 2950 or inter-electrode channel 2800). Optionally, the chemical reaction product is formed at or a reactant is reacted at, the anodes 2600 and the product or reactant is transported through the anode channel 2900. Optionally, the chemical reaction product is formed at, or a reactant is reacted at, the cathodes 2700 and the product or reactant is transported through the cathode channel 2950. Optionally, a liquid electrolyte is transported through the inter-electrode channel 2800.

In another example, there is provided an anode leaf 2150 including an anode channel 2900, and a cathode leaf 2150 including a cathode channel 2950, and wherein an inter-electrode channel 2800 is provided between the anode leaf and the cathode leaf, and wherein the leafs and the channels are spiral-wound about the central axis 2005. In another example, there is provided a plurality of anode leafs 2150, a plurality of cathode leafs 2150, and a plurality of inter-electrode channels 2800.

In another example, there is provided a core element 2200 positioned at or about the central axis 2005. Optionally, the anode leaf 2150 and the cathode leaf 2150 are attached to the core element 2200 at different circumferential positions of the core element 2200. The plurality of anode leafs 2150 and the plurality of cathode leafs 2150 can be attached to the core element 2200 at different circumferential positions. In one example, the core element 2200 includes at least one gas channel, and/or at least one fluid channel. Optionally, the at least one gas channel is off-center of the core element 2200. Also optionally, the at least one fluid channel is off-center of the core element 2200. In one example, the inter-electrode channel 2800 is in gas communication and/or fluid communication with the core element 2200.

In another example, one or more of the at least one electrode pair (anode 2600 and cathode 2700) is electrically connected to a conducting element of the core element 2200. In another example, an external element 2500 is provided and positioned away from the central axis 2005. Optionally, the external element 2500 is attached to or near an end of one or more of the at least one electrode pair, which is opposite to an end near the central axis 2005. Optionally, the inter-electrode channel 2800 can be in gas communication and/or fluid communication with the external element 2500. In another example, one or more of the at least one electrode pair (anode 2600 and cathode 2700) is electrically connected to a conducting element of the external clement 2500.

Preferably, the core element 2200 extends longitudinally parallel to the central axis 2005. Also preferably, the external element 2500 extends longitudinally parallel to the central axis 2005.

In another example, there is provided at least one end cap 2400, preferably two end caps 2400. Optionally, the anode channel 2900, the cathode channel 2950 and/or the inter-electrode channel 2800 is in gas communication and/or fluid communication with the at least one end cap 2400. Optionally, there is provided a second end cap 2400, the anode channel 2900, the cathode channel 2950 and/or the inter-electrode channel 2800 in gas communication and/or fluid communication with the second end cap 2400.

Optionally, one or more of the at least one electrode pair are electrically connected to a conducting element of the at least one end cap 2400. Preferably, the conducting element is a busbar. One or more secondary busbars can be electrically connected to one or more of the at least one electrode pair (anode 2600 and cathode 2700). The one or more secondary busbars can be electrically connected to the busbar. In another example, the one or more secondary busbar are flexible and are spiral-wound in the cell 2000. In another example, the one or more secondary busbars extend in an axial direction 2005 of the cell 2000.

### A.2. Example Components of Spiral-Wound Modules—Leafs

It should be appreciated that a leaf is comprised of one or more electrodes, for example an electrode, a pair of electrodes, a plurality of electrodes, or some other form of electrode unit. A leaf is flexible and can be repeated as a unit.

For example, a leaf can include in part, or be formed by:

one or a single electrode, for example a single cathode or a single mode or a single anode;

a single sheet of electrode material that is folded or two sheets that are connected to provide two electrodes, for example two cathodes or two anodes;

two electrodes, for example two cathodes or two anodes;

an electrode pair, for example an anode and a cathode; or

a plurality of any of the above.

FIGS. 1(d)-(j) illustrate several of the forms that a leaf may take. FIG. 1(d) shows a leaf that is a single anode 2600. FIG. 1(e) shows a leaf that is a single cathode 2700. FIG. 1(f) shows a leaf that is a single sheet of electrode material that is folded or two sheets that are connected to provide two anodes 2600, which enclose an anode channel 2900. FIG. 1(g) shows a leaf that is a single sheet of electrode material that is folded or two sheets that are connected to provide two cathodes 2700, which enclose, a cathode channel 2950. FIG. 1(h) shows a leaf that is two anodes 2600, which enclose an anode channel 2900. FIG. 1(i) shows a leaf that comprises two cathodes 2700, which enclose a cathode channel 2950. FIG. 1(j) shows a leaf that comprises an anode 2600 and a cathode 2700, which together enclose an inter-electrode channel 2800.

In another example, a leaf can include in part, or be formed by, two electrode material layers (with both layers together for use as an anode or a cathode) that are positioned on opposite sides of an electrode channel spacer (i.e. a spacer material, layer or sheet, which for example can be made of a porous polymeric material) which provides a gas and/or liquid channel between the two electrodes.

In another example, a leaf can include in part, or be formed by, two electrode material layers (with one electrode material layer for use as an anode and one electrode material layer for use as a cathode) that are positioned on opposite sides of an inter-electrode channel spacer (i.e. a spacer material, layer or sheet, which for example can be made of a porous polymeric material) which provides a gas and/or liquid channel between the two electrodes (i.e. between the anode and the cathode).

In another example, a leaf can include in part, or be formed, by, a single electrode material layer (for use as an anode or as a cathode). In another example, the electrode material layer can be positioned adjacent a channel spacer (i.e. a spacer material, layer or sheet, which for example can be made of a porous polymeric material) which provides a gas and/or liquid channel.

Repeated leafs provide a multi-electrode array being a series of spiral-wound electrodes with intervening spacers providing separated gas and/or liquid channels. The electrode channel spacer can be a different, or in one example the same, material as the inter-electrode spacer. The electrochemical cell, module or reactor may optionally also involve end caps, and one or more, external elements.

### A.3. Example Components of Spiral-Wound Modules—Anodes and Cathodes

The anodes and cathodes described above are preferably, but not exclusively 3D electrodes and Gas Diffusion Electrodes (GDEs). A general feature of gas diffusion electrodes is that they form an electrically active interface between to liquid on one side of the electrode and a gas on the other side of the electrode. Thus, anodes and cathodes of the present invention preferably, but not exclusively, form interfaces between a gaseous atmosphere on one side and a liquid environment on the other.

In a first form, the anodes and cathodes described above are preferably, but not exclusively, conventional 3D electrodes and Gas Diffusion Electrodes (GDEs) of types that may be purchased commercially or fabricated from standard components using established industry methods.

In a second form the anodes and cathodes described above are preferably, but not exclusively, 3D electrodes and Gas Diffusion Electrodes (GDEs) of the types described in the Applicant's previously filed International Patent Application No. PCT/AU2014/050160 for “Composite Three-Dimensional Electrodes and Methods of Fabrication” filed 30 Jul. 2014, that is hereby incorporated by reference.

In a third form, the anodes and cathodes described above are preferably, but not exclusively, hybrid 3D electrodes and Gas Diffusion Electrodes (GDEs) that combine the properties, components, and fabrication methods of conventional 3D electrodes and Gas Diffusion Electrodes (GDEs) with the properties, components, and fabrication methods of the Applicant's previously filed International Patent Application No. PCT/AU2014/050160 for “Composite Three-Dimensional Electrodes and Methods of Fabrication” filed 30 Jul. 2014, that is hereby incorporated by reference.

In further examples, electrochemical cells can be provided, wherein: the anode comprises a gas diffusion electrode, and/or the cathode comprises a gas diffusion electrode, and wherein the gas diffusion electrode comprises substantially of carbon and/or polytetrafluoroethylene (PTFE). In still further examples, electrochemical cells can be provided, wherein: (1) the anode comprises: (a) a gas diffusion electrode including a gas permeable material that is non-conductive, and a porous conductive material attached to the gas permeable material, or (b) a gas diffusion electrode including a gas permeable material that is non-conductive, and a fused, porous layer of conductive particles, or (c) a gas diffusion electrode including a fused, porous layer of conductive particles: and/or (2) the cathode comprises: (a) a gas diffusion electrode including a gas permeable material that is non-conductive, and a porous conductive material attached to the gas permeable material, or (b) a gas diffusion electrode including a gas permeable material that is non-conductive, and a fused, porous layer of conductive particles, or (c) a gas diffusion electrode including a fused, porous layer of conductive particles.

### A.3.1 Anodes and Cathodes Comprising Conventional 3D Electrodes and GDEs

Conventional, commercially available Gas Diffusion Electrodes (GDEs) typically comprise of fused, porous layers of conductive particles (usually carbon particles) of different size. The outer-most layers typically contain particles of the smallest dimensions, fused together with smaller amounts of hydrophobic PTFE (polytetrafluoroethylene, or Teflon™) binder. The inner-most layers typically contain the largest particles. There may be multiple intermediate layers of intermediate particle size.

The intention of this gradation in particle size within GDEs, from largest in the center to smallest on the outer sides, is to create and control a three-phase solid-liquid-gas boundary within the electrode. This boundary should have the largest possible surface area. The creation of such a boundary is achieved, effectively, by controlling the average pore sizes between the particles, ensuring that the smallest pore sizes are at the edges and the largest are in the center. Since the pores are typically relatively hydrophobic (due to the PTFE binder), the small pore sizes at the edges (e.g. 30 microns pore size) act to hinder and limit the ingress of liquid water into the GDE. That is, water can penetrate only a relatively short distance into the GDE, where the electrochemically active surface area per unit volume, is largest. By contrast, the larger pores in the center of the GDE (e.g. 150 microns pore size) allow for ready gas transmission at low pressure along the length of the GDE, with the gas then forming a three-way solid-liquid-gas boundary with the liquid water at the edges of the GDE, where the electrochemically active surface area per unit volume is the largest.

At the present time, conventional 3D particulate fixed bed electrodes and gas diffusion electrodes (GDEs) are fabricated by mixing carbon black and PTFE powders and then compressing and/or sintering the solid mixture into a bulk, porous electrode.

The pore size of the resulting, structure may be very roughly controlled by managing the particle size of the particulates used. However, it is difficult to achieve a uniform pore size throughout the electrode using this approach because particles, especially “sticky” particles like PTFE, often do not flow evenly and distribute themselves uniformly when compressed and/or sintered. A wide range of pore sizes are therefore typically obtained. It is, moreover, generally not possible to create structures with uniformly small pore sizes, such as 0.05 μm-0.5 μm in size.

The hydrophobicity of the structure is typically controlled by managing the relative quantity of PTFE incorporated into the structure. The PTFE holds the structure together and creates the required porosity. However, its quantity must be carefully controlled so as to impart the electrode with an appropriately intermediate hydrophobicity. An intermediate hydrophobicity is needed to ensure partial, but not complete water ingress. In the case of GDEs, this is needed to thereby create a solid-liquid-gas boundary within the carbon black matrix that makes up the electrode.

Conventional Gas Diffusion Electrodes of this type are sold by companies such as, for example. NuVant Systems Inc. of Crown Point, Ind.

### A.3.2 Anodes and Cathodes Comprising Novel 3D Electrodes and GDEs

In a second and an alternative form, the 3D electrodes and Gas Diffusion Electrodes (GDEs) may be of the types described in the Applicant's previously filed International Patent Application No. PCT/AU2014/050160 for “Composite Three-Dimensional Electrodes and Methods of Fabrication” filed 30 Jul. 2014, that is hereby incorporated by reference.

In one example, 3D electrodes or GDEs of this type are distinguished from conventional particulate fixed-bed GDEs in that they separate the key features of a 3D electrode or GDE into two, or at least two, distinct regions, each of whose properties improve upon and may be more fully controlled than is possible within the single body of a conventional GDE. An example embodiment of such a 3D electrode or GDE may comprise a liquid-and-gas-porous conductive material, which can optionally also include a catalyst which is enhanced or optimized for its catalytic capabilities and conductivity. The conductive material is attached to coupled to, touching, positioned adjacent to, or abuts, a gas permeable material that is non-conductive and liquid electrolyte impermeable during normal operational use of the electrode, e.g. which may be hydrophobic, for which the pore structure is selected, enhanced or optimised for gas transport properties. Normal operational use is, for example, when the electrode is functioning as intended and not flooded. In an example, a surface of the as permeable material is facing the porous conductive material. The surface of the gas permeable material may, but need not necessarily, touch or contact the porous conductive material, for example there may be an intermediary binder material or layer that can include one or more catalysts. At or near the surface of the gas permeable material is an interface or boundary region of the gas permeable material and the porous conductive material. When the electrode is in use, a three-phase solid-liquid-gas boundary is able to form at or near the surface of the gas permeable material facing the porous conductive material. In this context, “at or near” the surface is intended to mean within a distance, being the thickness of a binder material (if present, and as discussed herein), or within a distance being the macroscopic width of the three-phase solid-liquid-gas boundary itself, or within a distance of any overlap of the gas permeable material and the porous conductive material, or within a distance being the width of the porous conductive material. The three-phase solid-liquid-gas boundary need not form precisely “at” the surface, but can form “near” the surface in the sense of being close, neighbouring, adjoining, immediately next to or within, or proximate. The three-phase solid-liquid-gas boundary can further move in response to the application of an excess gas or liquid pressure, however the boundary will remain ‘near’ to the surface as described during normal operational use.

Preferably, two regions (being a first region including the porous conductive material and a second region including the non-conductive gas permeable material) are substantially distinct, demarcated or separated, although they are positioned adjacent, abut, touch or adjoin each other, so that there is an interface or a boundary region, or possibly an overlap.

In such a 3D electrode or GDE, the non-conductive, liquid electrolyte impermeable or hydrophobic, gas permeable material has pores that are better defined, more uniform, and of smaller average size, than can be achieved in a conventional GDE. The liquid-and-gas-porous conductor, preferably provided with a catalyst, may be more conductive than a conventional GDE, while its low hydrophobicity may see the porous conductor completely or substantially completely ailed with liquid electrolyte under normal operating conditions, thereby enhancing or maximally facilitating catalysis. In contrast, in a preferred form, the high hydrophobicity of the non-conductive, hydrophobic, gas permeable material will typically see the gas permeable material completely empty or substantially empty of liquid electrolyte at atmospheric pressure, thereby enhancing or maximally facilitating gas transport into and out of the GDE.

When such an example embodiment 3D electrode or GDE is contacted on the conductive side by a liquid electrolyte and on the non-conductive side by a gaseous material, then the above physical features cause the formation of a three-phase solid-liquid-gas boundary at or near a surface of the gas permeable material facing the porous conductive material, which also can be at the interface between the two distinct regions. This boundary is quite different to the three-phase solid-liquid-gas boundary in a conventional GDE. It differs in that it is better defined, narrower, more stable and/or more robust than can be achieved in a conventional GDE. Thus, in operation of a preferred embodiment, a three-phase solid-liquid-gas boundary forms at or near as surface of the gas permeable material facing the porous conductive material (which may also be at the interface, or a boundary region of the porous conductive material, which can include a catalyst, and the non-conductive gas permeable material). This provides a three-phase solid-liquid-gas boundary with a relatively narrow macroscopic width, for example in comparison to the width or thickness of the electrode.

These features are important because 3D electrodes or GDEs of this type can provide, at or near the interface of the two regions, an enhanced or optimum pore structure, for example hydrophobic pore structure, that facilitates improved or maximum gas transport, with an enhanced or optimally conductive, improved or maximally catalytic structure. In effect at the three-phase solid-liquid-gas boundary in example embodiment 3D electrodes or GDEs, each of the critical properties of a gas diffusion electrode may be made ideal, or, at least, nearer to ideal than is otherwise possible.

The effect of this enhancement or optimisation yields surprising and remarkable electrochemical performance. Despite the three-phase solid-liquid-gas boundary being narrower and confined to what appears to be a two dimensional (2D), or substantially 2D, macroscopic geometry, the electrochemical capabilities of the three-phase solid-liquid-gas boundary in example embodiment 3D electrodes or GDEs substantially improves upon and, in fact, may exceed those of conventional GDEs. Such three-phase solid-liquid-gas boundaries can, for example, impart example embodiment 3D electrodes or GDEs with a range of unexpected and novel electrochemical capabilities, including:
a. much higher wetting pressures and bubble points than can be achieved in conventional GDEs, “Wetting pressure” is defined as the lowest excess of pressure on the liquid electrolyte side of a GDE relative to the gas side of the GDE, at which the liquid electrolyte penetrates and floods the GDE. The “bubble point” is defined as the lowest excess of pressure on the gas side of a GDE relative to the liquid electrolyte side of the GDE, at which the gas blows through the GDE and forms bubbles at the electrode surface on the liquid electrolyte side. Example embodiment GDEs typically have wetting pressures and bubble points in excess of 0.2 bar, whereas conventional GDEs typically have wetting pressures and bubbles points of 0.2 bar or less;
b. lower electrical resistances, higher electrocatalytic activities and reactivities, as well as more efficient utilization of catalytic materials, if used, than can be realised in conventional GDEs, especially, but not exclusively, when operated at relatively low current densities; and
c. an apparent capacity to facilitate hitherto unachievable gas-to-liquid or liquid-to-gas electrochemical reactions, or, at least, improve upon electrochemical reactions that have not proved practically viable to date, especially, but not exclusively, when operated at relatively low current densities.

Thus, in particular examples, such 3D electrodes or GDEs display a uniquely and an exceedingly well-defined, narrow, stable, and/or robust three-way solid-liquid-gas interface. One effect created by such an interface an unusually high electrochemical and catalytic activity that derives from the high quality of the liquid-solid-gas interface. For example, GDEs of this type may be able to spontaneously, aggressively and selectively sequester oxygen from the atmosphere, even though oxygen makes up only 20% of the atmosphere. Thus, example GDEs of this type may be used to facilitate the Dow Huron process in a more electrically and economically efficient manner than has hitherto been possible. Similarly, example GDEs have proved able to facilitate the hitherto unknown reactions that occur in a room temperature direct methane fuel cell.

These enhancements provide unexpected improvements over conventional GDEs. They appear to arise because the fabrication of conventional particulate fixed-bed GDEs as currently employed in the art, is predicated on creating all of the important physical properties at the same time within a single material. Such an approach effectively ignores the fact that the key properties of GDEs (namely: pore structure, hydrophobicity, gas transport, liquid transport, conductivity and catalytic activity) are typically inter-dependent and are therefore not open to ready, concurrent enhancement or optimisation within a single material. Example embodiment GDEs as described herein take account of this limitation and separately optimise one or more of the key properties, to thereby achieve more ideal overall properties at the interface of the two distinct regions.

GDEs of this type may also be fabricated in an exceedingly low cost manner, allowing for the practical use of: (i) relatively low current densities, which minimise electrical losses and maximise electrical efficiency and/or (ii) low-cost catalysts comprising of Earth-abundant elements which only operate efficiently at lower current densities. By these means, it becomes possible to manufacture, practically and economically viably, large-scale electrochemical cells for use in industrial-scale electro-synthetic and electro-energy applications. Such cells may achieve energy efficiencies that have hitherto been unavailable in large-scale production and energy environments. For example, chlorine may be manufactured at scale using the chlor-alkali process with 91% energy efficiency, whereas the best available industrial chlor-alkali plants achieve 66% energy efficiency.

These and other advantages are described in the Applicant's previously filed International Patent Application No. PCT/AU2014/050161 for “Modular Electrochemical Cells” filed 30 Jul. 2014, the Applicant's previously filed International Patent Application No. PCT/AU2014/050162 for “Electro-Synthetic or Electro-Energy Cell With Gas Diffusion Electrode(s)” filed on 30 Jul. 2014, and the Applicant's previously filed international Patent Application No. PCT/AU2014/050158 for “Method and Electrochemical Cell for Managing Electrochemical Reactions” filed on 30 Jul. 2014, which are all incorporated herein by reference.

3D electrodes and GDEs of this type may be fabricated by using an expanded PTFE (ePTFE) membrane for the gas permeable material that is non-conductive and liquid electrolyte impermeable. To this is attached the liquid-and-gas-porous conductive material, to thereby create the GDE.

For example, a typical fabrication process involves selecting an ePTFE membrane manufactured by General Electric Company for the water treatment industry (pore site 0.2 micron). The membrane had a fine nickel mesh (200 line per inch; manufactured by Precision cForming Inc.) laid down upon it. The mesh was then carefully lifted, starting at one edge and a layer of a binder material (15% Nafion in alcohol/water; supplied by Ion Power Inc., containing 10% by weight of carbon black, supplied by Sigma-Aldrich) was applied to the membrane surface. The mesh was thereafter released and allowed to contact the coated membrane. After leaving to dry for 4 hours at 60° C., the mesh was adhered to the surface of the PTFE membrane. This fabrication method may be amended in several ways. The binder material may be applied or painted over the unconnected mesh and the membrane and then dried, causing the mesh to adhere to the membrane. Alternatively, the binder material may be separately applied to the membrane surface and the mesh, with the coated, wet membrane and mesh then married up and dried. The combination may optionally be compressed and laminated together. This provides a type of flexible electrode that can be spiral-wound.

### A.3.3 Anodes and Cathodes Comprising Hybrid 3D Electrodes and GDEs

In a third and a still further alternative form, the anodes and cathodes described above are preferably, but not exclusively, hybrid 3D electrodes and Gas Diffusion Electrodes (GDEs) that combine the properties, components, and fabrication methods of:
conventional 3D electrodes and Gas Diffusion Electrodes (GDEs)
   with the properties, components, and fabrication methods of:
the Applicant's previously filed International Patent Application No. PCT/AU2014/050160 for “Composite Three-Dimensional Electrodes and Methods of Fabrication” filed 30 Jul. 2014, which is incorporated herein by reference.

In an example embodiment, an ePTFE membrane manufactured by General Electric Company for the water treatment industry (pore size 0.2 micron), is selected to be the gas permeable material that is non-conductive and liquid electrolyte impermeable. This selection is in accordance with the fabrication principles of the novel 3D electrodes and GDEs described above.

A fine nickel mesh (200 line, per inch; manufactured by Precision eForming Inc.) is then laid upon the ePTFE membrane, again in accordance with the fabrication principles of the novel 3D electrodes and GDEs described above.

However, instead of then applying a liquid-and-gas-porous conductive material to the ePTFE and Ni mesh, to thereby create a novel GDE, a conventional mixture of conductive carbon black and PTFE containing a catalyst (e.g. Pt) is applied. For example, a mixture that is 50% (w/w) PTFE and 50% (w/w) carbon black (coated with Pt in the ration 0.2 g Pt per square metre of coverage), may be used.

Following drying and compression of the resulting carbon-black—PTFE—catalyst matrix, the resulting GDE has both a nonconductive gas permeable, liquid impermeable element (namely, the ePTFE membrane) and a conventional conductive carbon black—PTFE—catalyst matrix present.

In combining features of a conventional GDE with the novel GDE described above, the resulting electrode (anode or cathode) can be considered to be a hybrid 3D electrode or GDE. This provides a type of flexible electrode that can be spiral-wound.

It is to be understood that all such combinations of features of conventional 3D electrodes and GDEs with features of the novel GDEs described above, may comprise anodes and/or cathodes of various embodiment of the invention.

### B. General Methods of Spiral-Winding—Gas/Liquid Plumbing of a Spiral-Wound Module

An important feature of a spiral-wound electrochemical cell or module is the need for convenient and efficient pathways within the module, with which to separately plumb the reactant or product gases and/or liquids, including liquid electrolyte(s). By this is meant that sealed gas/liquid connection pathways need to be created for each of the available channel types, most preferably, but not necessarily, such that a single inlet and/or single outlet exists for each channel type in the cell or module.

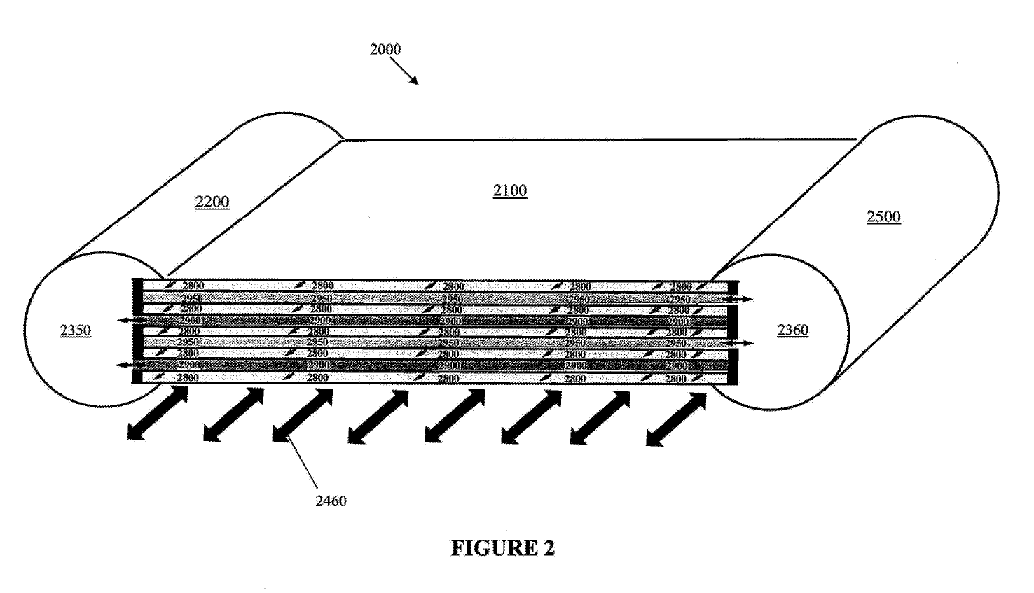

FIG. 2 schematically depicts an illustrative example in this respect. The schematic shows how the cathode channels 2950, anode channels 2900, and inter-electrode channels 2800 within a multi-electrode array 2100 may be plumbed. FIG. 2 shows an example unwound multi-electrode array 2100 of electrodes, formed at least partially of flexible leafs 2150, which can be rolled in a spiral manner, in which the anode channels 2900 have been plumbed into (i.e. are open to, are in gaseous communication with, or are in fluid communication with) the core element 2200, the cathode channels 2950 have been plumbed into (i.e. are open to, are in gaseous communication with, or are in fluid communication with) the external clement 2500, and the inter-electrode channels 2800 are sealed from both the core element 2200 and the external element 2500 but are open in (i.e. are in gaseous communication with or are in fluid communication with) the direction perpendicular to the length of the leaf (axial direction when rolled) toward the end caps (not illustrated). The number of electrodes shown is provided by way of example only and the core/external elements are not to scale with the electrodes (for clarity).

In the schematic in FIG. 2, the anode channels 2900 have all been plumbed into a tube formed by the core element 2200. That is the anode channels have all been sealed such that they are only in fluid communication with a single tube in the core element. The products 2350 from the anodes, or the reactants 2350 needed at the anodes, may flow via this single tube of the core element 2200. The cathode channels 2950 in FIG. 2 have similarly all been plumbed into a tube formed by the external element 2500. That is the cathode channels have all been sealed such that they are only in fluid communication with a single tube in the external element. The products 2360 from the cathodes or the reactants 2360 needed at the cathodes, may flow via this single tube of the external element 2500. The inter-electrode channels 2800 in FIG. 2 have been sealed and excluded from both of the core element and the external element. However, they have been left open in the direction perpendicular to the axis between the core element and the external element and in a plane which is substantially parallel to the ends of the core element and the external element. That is, they are open in the direction perpendicular to the spiral-winding (which occurs around the core element and leaves the external element on the outside of the spiral-wound module). This direction 2460 is shown by the large arrows, which point toward the end cap. These channels may be plumbed through the end caps, or the end caps may be made porous such that the fluid for the inter-electrode channels fills the space all around the module. It is to be understood that the plumbing scheme shown in FIG. 2 is illustrative only. Many other embodiments may exist. For example, cathode channels may be plumbed to the core element and anode channels may be plumbed to the external element. Further examples are described below.

### B.1. General Methods of Spiral-Winding—Gas/Liquid Plumbing Through the Core Element

The gas/liquid plumbing channels of the flexible electrodes may be conveniently brought together, collected, or accumulated into a single gas/liquid plumbing inlet/outlet by utilizing a conduit for gas/liquid plumbing in the core element of the spiral-wound cell.

Thus, there is provided a convenient and efficient configuration, arrangement, or design for a core element of spiral-wound electrochemical cells, modules or reactors, such that the core element is fabricated to incorporate at least one conduit down its length for a flexible leaf of the multi-electrode array, and where the flexible leaf comprises of a sealed gas/liquid channel with its associated electrode or electrodes. A repeat unit of electrodes with their associated, sealed gas-liquid channel is referred to herein as a “leaf” in the multi-electrode array.

There is further provided as core element for a spiral-wound electrochemical the core element comprising: at least one conduit provided lengthways along the core element; and, an aperture or series of apertures provided lengthways along the core element and associated with the at least one conduit; wherein, the aperture is able to receive an end from, or part of an end from, or gas from, or liquid from a flexible electrode, where the flexible electrode is able to be spiral-wound about the core element. In another embodiment, the aperture is able to provide a lip to, or part of a lip to, or gas to, or liquid to a flexible electrode, where the flexible electrode is able to be spiral-wound about the core element.

In various examples the at least one conduit is a passageway, cavity or channel suitable for transporting gas or liquid along an internal length of the core clement. The at least one conduit can have an ellipsoidal or tear-drop shaped cross-section. The at least one conduit provides a gas or liquid communication channel. The core element can be fabricated from a polymeric material. Optionally, the aperture is lipped or flanged. Preferably, the aperture is located on an external surface of the core element. Optionally, the aperture or series of apertures is/are provided lengthways along part of the length of the core element. Alternatively, the aperture is provided lengthways along the full length of the core element.

The core element may include two, four, six, eight or more conduits and two, four, six, eight or more apertures and be able to receive two, four, six, eight or more flexible electrodes. An insulating flexible spacer is positioned adjacent an electrode and the flexible electrode and the insulating flexible spacer are spiral-wound about the core element. The core element and spiral-wound electrode can be enclosed in a case or housing.

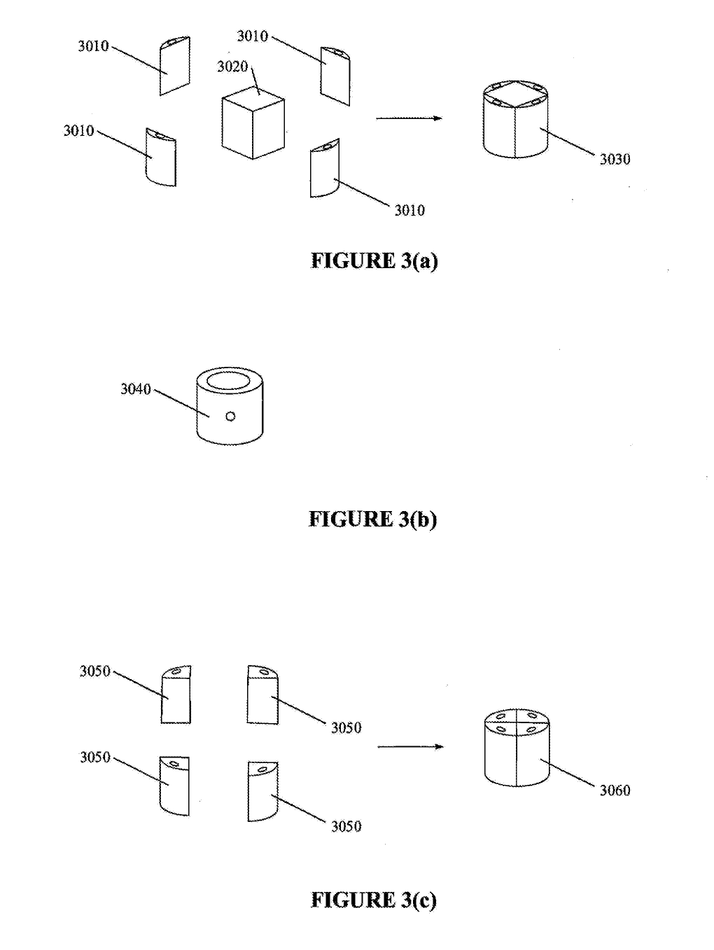

The gas/liquid plumbing connection between a leaf or leafs and its/their conduit is preferably but not exclusively achieved by one of the following means: (FIGS. 3(a) to 3(c) schematically illustrates these approaches)
i. “Conduit and Central Unit Assembly”: Referring to FIG. 3(a), in one example, the conduit is fabricated as part of a stand-alone unit, to which a leaf may be sealed, glued, welded, potted, or otherwise attached in such a way that the aperture/s of the conduit is/are in fluid communication with the gas/liquid channels within the leaf. The stand-alone conduit unit 3010 with its attached leaf, may then be sealed, glued, welded, or otherwise attached to a separate central unit 3020, to thereby create the core element 3030 (with the leaf attached). The core element 3030 is therefore created by the assembly of the stand-alone conduit unit (with its attached leaf) and the central unit. Alternatively, the leaf may be sealed, glued, welded, or otherwise attached to the central unit which is then sealed, glued, welded, or otherwise attached to the conduit unit 3010. A third alternative is that the leaf may be sealed, glued, welded, or otherwise attached to both the conduit unit 3010 and the central unit 3020 at the time that they are sealed, glued, welded, or otherwise attached to each other. The common feature of all of these approaches is that the core element 3030 is created by the assembly of the stand-alone conduit unit and the central unit, with the leaf attached prior to or during the time that the core element is created.
ii. “Direct Attachment”: Referring to FIG. 3(b): in another example, the core element 3040 is fabricated as a single cylindrical or cylinder-like unit containing at least one conduit or proto-conduit, to which its leaf or leafs may be sealed, glued, welded, potted or otherwise attached in such a way that the aperture/s of the at least one conduit in the core element is/are in fluid communication with the gas/liquid channels within the leaf associated with that conduit.
iii. “Conduit Unit Assembly”: Referring to FIG. 3(e), in a still further example, the conduit is fabricated within a stand-alone unit, to which the leaf is sealed, glued, welded, potted or otherwise attached in such a way that the aperture/s of the conduit is/are in fluid communication with the gas/liquid channels within the leaf. One or more conduit units 3050, with their attached leafs are then sealed, glued, welded, potted or otherwise attached together, to thereby create the core element 3060 out of the combined stand-alone conduit units 3050 teach of which has their leaf attached). This method differs from the Conduit and Central Unit Assembly method only in the absence of a central unit.

### B.2. General Methods of Spiral-Winding—Gas/Liquid Plumbing Through an End Cap, or at a Axial End of the Spiral-Wound Module

The gas/liquid plumbing channels of the flexible electrodes may be conveniently brought together, collected, or accumulated into a single gas/liquid plumbing inlet/outlet by utilizing a conduit for gas/liquid plumbing in the end caps of the spiral-wound cell.

Thus, there is provided a convenient and efficient configuration, arrangement, or design for an end cap of spiral-wound electrochemical cells, modules or reactors, such that the end cap is fabricated to incorporate at least one conduit for a flexible leaf of the multi-electrode array, where the flexible leaf comprises of a sealed gas/liquid channel with its associated electrode or electrodes and the flexible leaf is capable of being wound in a spiral shape.

There is further provided an end cap for a spiral-wound electrochemical cell, the end cap comprising: at least one conduit within the end cap; and, an aperture or series of apertures provided in the end cap and associated with the at least one conduit; wherein, the aperture is able to receive an end from, or part of an end from, or gas from, or liquid from a flexible electrode, where the flexible electrode is spiral-wound about a core element. In another embodiment, the aperture is able to provide a lip to, or part of a lip to, or gas to, or liquid to a flexible electrode, where the flexible electrode is spiral-wound about a core element.

In various examples the at least one conduit is a passageway, cavity or channel along an internal part of the end cap. Preferably but not exclusively, the conduit can have a u-shaped, an ellipsoidal or a tear-drop shaped cross-section. The conduit provides a gas or liquid communication channel. The cud cap can be fabricated from a polymeric material. Optionally, the aperture is lipped or flanged. Preferably, the aperture is located on an external surface of the end cap. Optionally, the aperture or series of apertures is/arc disposed in a spiral arrangement along the end cap, to thereby facilitate sealing, gluing, or bonding attachment to a flexible electrode leaf that has been spiral-wound about a core element.

The end cap may include two, four, six, eight or more conduits and two, four, six, eight or more apertures and be able to receive two, four, six, eight or more flexible electrodes. An insulating flexible spacer is positioned adjacent an electrode and the flexible electrode and the insulating flexible spacer are spiral-wound about the core element. The end-cap, core element and spiral-wound electrode can be enclosed in a case or housing.

In an alternative aspect, the gas/liquid plumbing channels of the flexible electrodes may be conveniently brought together, collected, or accumulated into a single gas/liquid plumbing inlet/outlet within a sealed tubular reactor in which the spiral-wound module has been placed. In this aspect, the gas/liquid may optionally pass through the end caps of the spiral-wound cell, or, if no end caps are present, the gas/liquid may enter/exit the spiral-wound module from the sides, with the encasing tubular reactor then providing the means for bringing together, collecting, or accumulating the gas/liquid into a single gas/liquid plumbing inlet/outlet.

In one example embodiment, an electrolyte exists between the leafs and enters the spiral-wound electrochemical cell from the axial end and optionally may be able to enter or exit the module from both axial ends (i.e. from the distal ends at different positions along the axial direction) and optionally flow from one axial end to another. In another embodiment, an electrolyte exists between the leafs and enters the spiral-wound electrochemical cell from either the core element, or from the outermost ends of the leafs on the axial length. In another embodiment, the cathode or anode product(s) exits the spiral-wound electrochemical cell from the leaf at either one or both of the axial ends. In further embodiments, the cathode or anode reactant enters the spiral-wound electrochemical cell from the leaf at either one or both of the axial ends. In another embodiment, the reaction product exits the spiral-wound electrochemical cell from either the central core element or from the outermost ends of the leafs on a radial end, e.g. via an external element, (i.e. from the end at the beginning of the spiral or the end at the end of the spiral). In one preferred embodiment, an electrolyte enters and exits from the axial ends and the reaction product(s) exits the spiral-wound electrochemical cell from the central core element.

The gas/liquid plumbing connection between a leaf or leafs and its/their conduit is preferably but not exclusively achieved by one of the following means:
i. “End-Cap Conduit”: In one example, the conduit is fabricated within an end-cap and the conduit is then plumbed to a lead or leafs. This may occur via a single or multiple plumbing connections between the end cap and the leaf/s. Alternatively, it may involve a continuous plumbing attachment between the end cap and the leaf/d. For example, the conduit may be incorporated as a spiral shaped groove within a spiral-shaped end-cap. A leaf is fed along the groove until the leaf fills the entire groove. The leaf and spiral-shaped end cap are then sealed, glued, welded, potted or otherwise attached to each other in such a way that the conduit formed by the spiral-shaped groove is in fluid communication with the gas/liquid channels within the leaf. An example illustrating this method is provided later in the specification.
ii. “Axial” Plumbing; In another example, the end-caps are porous or there are no end caps present, so as to thereby permit the free flow of gas/liquid through to the spiral-wound flexible electrode in a direction perpendicular to the direction of spiral winding. In this way, an anode, cathode or inter-electrode channel within a spiral-wound multi-electrode array may be sealed to the core element and any external element, but may be open to axial flow in a direction perpendicular to the spiral-winding of the leafs. Such axial flow may optionally be through a porous end cap. The liquid or gas may enter or exit the module from both axial ends and optionally flow from one axial end to another. FIG. 2 illustrates a cell whose inter-electrode channels have been axially plumbed. Other examples are discussed elsewhere.

### B.3. General Methods of Spiral-Winding—External Gas/Liquid Plumbing

The gas/liquid plumbing channels of the flexible electrodes may be conveniently brought together, collected, or accumulated into a single gas/liquid plumbing inlet/outlet by utilizing a conduit for gas/liquid plumbing located on the outside of, and external to the spiral-wound cell.

Thus, there is provided a convenient and efficient configuration, arrangement, or design for spiral-wound electrochemical cells, modules or reactors, such that an external unit is fabricated to incorporate at least one conduit for a flexible leaf of the multi-electrode array, where the flexible leaf comprises of a sealed gas/liquid channel with its associated electrode or electrodes and the flexible leaf is capable of being wound in a spiral shape.

There is further provided an external unit for a spiral-wound electrochemical cell, the external unit comprising; at least one conduit within the external unit, and, an aperture or series of apertures provided in the external unit and associated with the at least one conduit; wherein, the aperture is able to receive an end from, or part of an end from, or gas from, or liquid from a flexible electrode, where the flexible electrode is spiral-wound about a core element. In another embodiment, the aperture is able to provide a lip to, or part of a lip to, or gas to, or liquid to a flexible electrode, where the flexible electrode is spiral-wound about a core element.

In various examples the at least one conduit is a passageway, cavity or channel along an internal part of the external unit. Preferably but not exclusively, the conduit can have a u-shaped, an ellipsoidal or a tear-drop shaped cross-section. The conduit provides a gas or liquid communication channel. The external unit can be fabricated from a polymeric material. Optionally, the aperture is lipped or flanged. Preferably, the aperture is located on an external surface of the external unit. Optionally, the aperture or series at apertures is/are disposed lengthways along the external unit, to thereby facilitate scaling, gluing, or bonding attachment to a flexible electrode leaf that is capable of being spiral-wound about a core element.

The external unit may include two, four, six, eight or more conduits and two, four, six, eight or more apertures and be able to receive two, four, six, eight or more flexible electrodes. An insulating flexible spacer is positioned adjacent an electrode and the flexible electrode and the insulating flexible spacer are spiral-wound about the core element, leaving the external unit located on the outside of the spiral-wound cell. The end-cap, core element, external unit and spiral-wound electrode can be enclosed in a case or housing.

The gas/liquid plumbing connection between a leaf or leafs and its/their conduit is preferably but not exclusively achieved by one of the following means:
i. “External Conduit”: In one example, the conduit is fabricated as part of a stand-alone unit, to which a leaf is sealed, glued, welded, potted or otherwise attached in such a way that the apertures of the conduit is/are in fluid communication with the gas/liquid channels within the leaf. The leaf is then spiral-wound around its other end, leaving the conduit on the outside of, and external to the spiral-wound assembly. FIG. 3 schematically illustrates this approach.

### C. General Methods of Spiral-Winding—Electrical Connecting the Individual Electrodes in a Spiral-Wound Module

An important feature of a spiral-wound electrochemical cell or module is the need for convenient and efficient methods with which to electrically connect the individual electrodes. By this is meant that techniques are needed to cumulatively connect the different anode electrodes and the different cathode electrodes, in various configurations, such that the module contains a single positive and single negative electrical outlet/inlet.

There are two general ways of consolidating electrical connections in spiral-wound modules:
(i) by connecting the ends of the electrodes in the flexible leafs at the start or end of the spiral, which is generally referred to in this specification as “Spiral Attachment”, or
(2) by connecting the ends of the electrodes in the flexible leafs on the sides of the spiral, which is generally referred to in this specification as “Axial Attachment”.

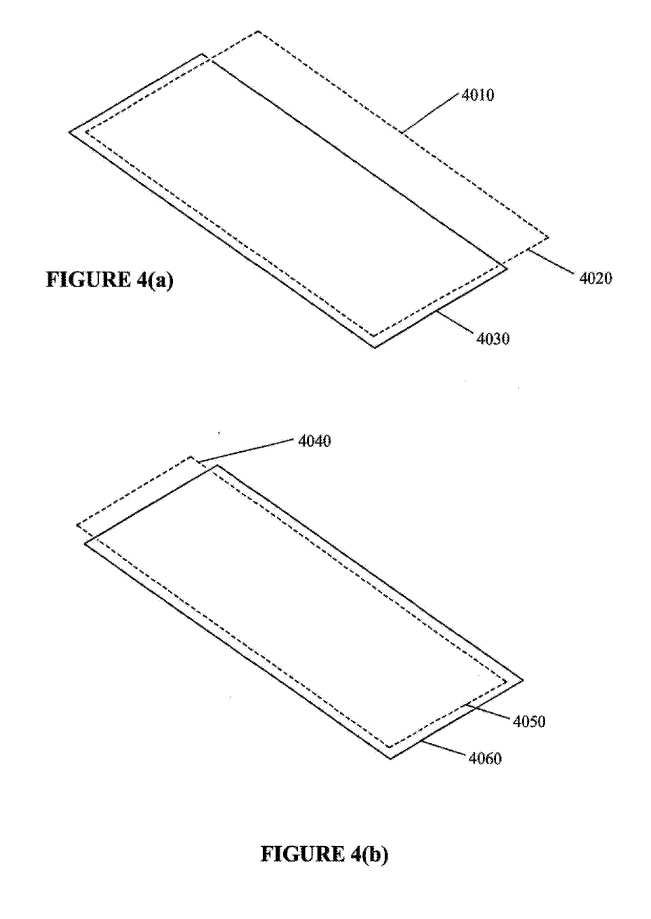

FIG. 4(a) schematically illustrates the Axial method and FIG. 4(b) schematically illustrates the Spiral method for connecting the individual electrodes in flexible leafs. In each case, the electrode is attached to a conducting element, preferably in the form of a primary busbar, from which the single positive or negative electrical inlet/outlet for the module originates. Referring to FIG. 4(a), the extended end 4010 of an electrode 4020 of a flexible leaf 4030 connects to a primary busbar located at or in place of an end cap. Referring to FIG. 4(b), the extended end 4040 of an electrode 4050 of a flexible leaf 4060 connects to a primary busbar. The primary busbar may be located in the core element, which is then termed an internal Spiral attachment, or the primary busbar may be located in an external element, which is then termed an External Spiral attachment.

### C1. General Methods of Spiral-Winding—Electrical Connection through an End Cap

In a further aspect, there is provided convenient and efficient configurations, arrangements, or designs for electrically connecting a flexible leaf or leafs of a single- or multi-electrode, array within a spiral-wound electrochemical cell, module or reactor, and were the flexible leaf comprises of a sealed gas/liquid channel with its associated electrode or electrodes.

The electrical connections of the flexible electrode leaf or leafs in a spiral wound cell may be conveniently brought together, collected, accumulated, or gathered into a single electrical conductor by utilizing electrically conducting elements in the end cap of a spiral-wound cell, in one aspect, an electrically conducting element is located in the end-cap and functions as a primary busbar for the cell.

In an embodiment thereof, one or more electrically conducting elements are disposed perpendicular to the helix of the spiral-winding of the flexible leaf/leafs, with their one end extending beyond the edge of the flexible leaf/leafs.

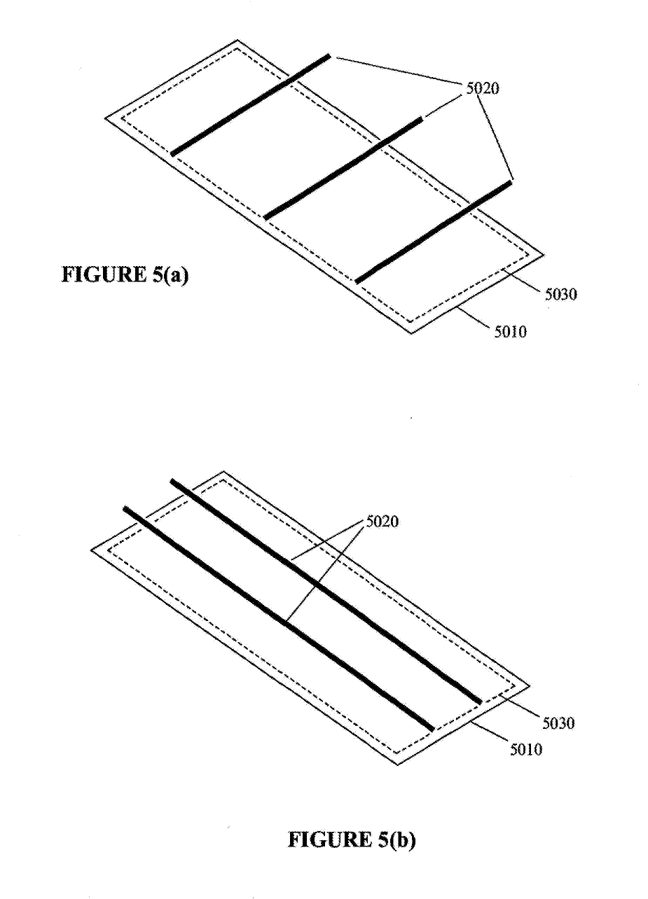

Referring to FIGS. 5(a) and 5(b), in one example, the perpendicularly-disposed electrically conducting elements are secondary busbars 5020 that are secured in conductive electrical contact to the electrode 5030 of the flexible leaf 5010, to thereby distribute current over the flexible electrode 5030. The end of the secondary busbar 5020 lying beyond the edge of the leaf leafs 5010 in FIG. 5(a) is further secured in conductive electrical contact to the primary busbar conducting element that is located in the end cap. This is known as Axial Busbar Attachment. The end of the secondary busbar 5020 lying beyond the edge of the leaf/leafs 5010 in FIG. 5(b) is further secured in conductive electrical contact to the primary busbar conducting element that is located in the core element or an external element. When the secondary busbar 5020 lying beyond the edge of the leaf/leafs 5010 in FIG. 5(b) is attached to the primary busbar in the core element, this is known as Internal Spiral Busbar Attachment. When the secondary busbar 5020 lying beyond the edge of the leaf leafs 5010 in FIG. 5(b) is attached to the primary busbar in an external element, this is known as External Spiral Busbar Attachment.

In another example, the perpendicularly-disposed electrically conducting elements are current collectors, such as conducting metal meshes, which may form the electrode of the flexible leaf/leafs. The end of the current collectors lying beyond the edge of the leaf/leafs arc then further secured in conductive electrical contact to the primary busbar conducting element that is located in the end cap. In this embodiment there is no secondary busbar between the electrode in the flexible leaf/leafs and the primary busbar in the end cap.

Embodiments further extend to methods for forming the electrical connection between the flexible electrode leaf and the module. These are preferably, but not exclusively, achieved by one of the methods described below:
i. “Axial Attachment”; In an example, the electrode of the flexible leaf is directly welded, soldered, glued with conductive glue, or otherwise attached in conductive electrical contact to a primary busbar located at or in place of an end cap. FIG. 4(a) illustrates the Axial Attachment method.
ii. “Axial Busbar Attachment”: In another example, the electrode, in the flexible leaf is welded, soldered, glued with conductive glue, or otherwise attached in conductive electrical contact to a secondary busbar, which is disposed across the flexible electrode, perpendicular to the direction of spiral-winding. The unattached end of the secondary busbar is further welded, soldered, glued with conductive glue, or otherwise attached in conductive electrical contact to a primary busbar located at or in place of an end cap. FIG. 5(a) illustrates the Busbar Attachment method.

While several configurations may be envisaged for the separate connection of the anodes and cathodes in the flexible electrode array, a particularly preferred embodiment involves conductively attaching all of the anodes to one end-cap and all of the cathodes to the other end-cap. This is referred to as Asymmetric Electrode Connections in this specification. To facilitate this design, all of the anode electrodes (or their secondary busbars) may be made to extend beyond the anode channels in the flexible sheet toward one end cap, while all of the cathode electrodes (or their secondary busbars) may be made to extend beyond the cathode channels in the flexible sheet toward the other end cap. The extended ends of the anode electrodes may then be welded, soldered or otherwise conductively attached to the primary busbar in the one end cap and the extended ends of the cathode electrodes may then be welded, soldered or otherwise conductively attached to the primary busbar in the other end cap.

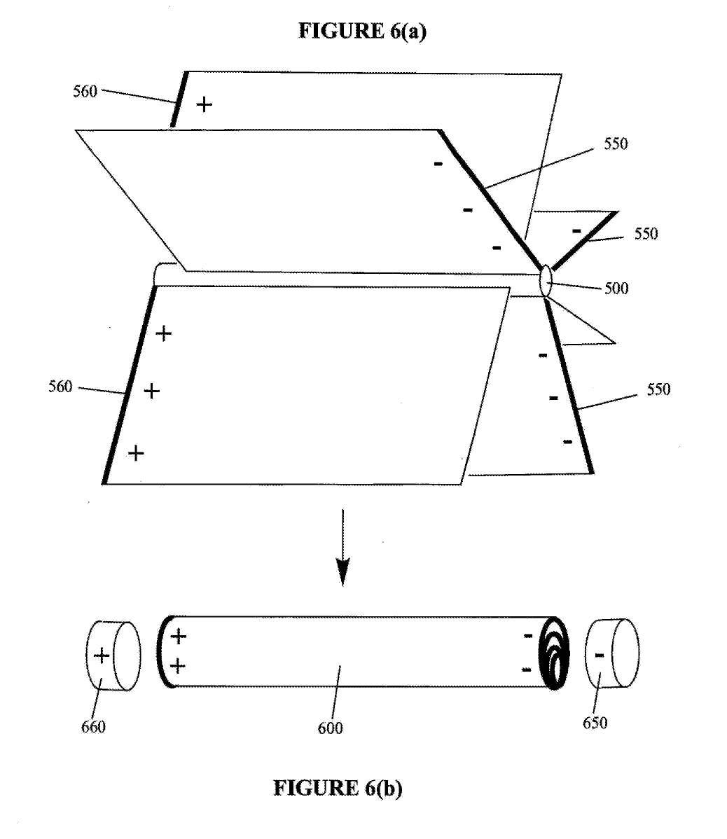

FIGS. 6(a) and 6(b) schematically illustrate this configuration for a flexible electrode array comprising three flexible sheets that form anode channels and three flexible sheets that form cathode channels. In such a configuration, there would normally be insulating, porous spacers between the cathode and anode sheet electrodes to prevent short circuits. These have not been shown in. FIG. 6 for clarity.

A core element 500 has arrayed about it 6 leafs, three of which contain cathode sheet electrodes 560 (each forming a cathode channel) and three of which contain anode sheet electrodes 550 (each forming an anode channel). Note that the anode sheet electrodes are displaced to the right-hand side of the core element, whereas the cathode sheet electrodes are displaced toward the left-hand side of the core element. When the assembly is now rolled up into a spiral-wound configuration 600, all of the electrodes protruding at the right end of the spiral-wound assembly 600 are anodes, which are shown as having a negative sign in FIG. 6. As such, they may be electrically connected by welding, soldering or gluing with conductive glues, to an electrically conductive primary busbar in end-cap 650, which then constitutes the negative electrical pole of the spiral-wound cell. Similarly, all of the electrodes protruding at the left end of the spiral-wound assembly 600 are cathodes, which are shown as having a positive sign in FIG. 6. As such, they may be electrically connected by welding, soldering or gluing with conductive glues, to an electrically conductive primary busbar in end-cap 660, which then constitutes the positive electrical pole of the spiral-wound cell. By this means, the electrical connections may be advantageously located in the end-caps of the spiral-wound assembly.

### C.2. General Methods of Spiral-Winding—Electrical Connection through the Core Element

The electrical connections of the flexible electrode leaf or leafs in a spiral-wound cell ma be conveniently brought tog the collected, accumulated, or gathered into a single electrical conductor by utilizing electrically conducting elements in the core element of a spiral-wound cell. In one aspect, an electrically conducting element is located length-wise along part or all of the length of the core element. In one example, the electrically conductive element functions as a primary busbar for the cell. In an embodiment thereof, one or more electrically conducting elements are disposed along the length of the leaf/leafs in the direction of the spiral-winding of the flexible leaf/leafs.

In one example, the spirally-disposed electrically conducting elements are secondary busbars that are secured in conductive electrical, contact to the electrode of the flexible leaf, to thereby distribute current over the flexible electrode. The end of the secondary busbar lying at the edge of the leaf/leafs is further secured in conductive electrical contact to the primary busbar conducting element that is located in the core element. In another example, the helically-disposed electrically conducting elements are current collectors, such as conducting metal meshes, which may form the electrode of the flexible leaf/leafs. The end of the current collectors at the edge of the leaf/leafs are then further secured in conductive electrical contact to the primary busbar conducting element that is located in the core element. In this embodiment there is no secondary busbar between the electrode in the flexible leaf/leafs and the primary busbar in the core element.

Embodiments include methods for forming the electrical connection between the flexible electrode leaf and the module. These are preferably, but not exclusively; achieved by one of the methods described below;
i. “Internal Spiral Attachment”: In one example the electrode of the flexible leaf is directly welded, soldered, glued with conductive glue, or otherwise attached in conductive electrical contact to a primary busbar located at, and running down all or part of the length of the core element. The primary busbar may be located within the core element, or it may be attached to the outside of the core element. FIG. 4(b) illustrates the Internal Spiral Attachment method.
ii. “Internal Spiral Busbar Attachment”: In another example, the flexible electrode leaf is welded, soldered, glued with conductive glue, or otherwise attached in conductive electrical contact to a secondary busbar, which is disposed across the flexible electrode, in the direction of spiral-winding. The unattached end of the secondary busbar is then welded, soldered or otherwise electrically attached to a primary busbar located at, and running down all or part of the length of the core element. The primary busbar may be located within the core element, or it may be attached to the outside of the core element. FIG. 5(b) illustrates the Internal Spiral Busbar Attachment method.

### C.3. General Methods of Spiral-Winding—External Electrical Connection

The electrical connections of the flexible electrode leaf or leafs in a spiral wound cell may be conveniently brought together, collected, accumulated, or gathered into a single electrical conductor by utilizing electrically conducting elements external to and outside of the spiral-wound cell.

In one aspect, an electrically conducting element is located length-wise along part or all of the outside length of the spiral-wound cell, external to the spiral-wound cell. In one example, the electrically conducting element functions as a primary busbar for the cell. In an embodiment thereof, one or more electrically conducting elements are disposed along the length of the leaf/leafs in the direction of the spiral-winding of the flexible leaf/leafs.

In one example, the electrically conducting elements disposed along the length of the leaf/leafs in the direction of the spiral-winding, are secondary busbars that are secured in conductive electrical contact to the electrode of the flexible leaf, to thereby distribute current over the flexible electrode. The outside end of the secondary busbar is further secured in conductive electrical contact to the primary busbar conducting element that is located outside of the spiral-winding, external to the spiral-wound cell.

In another example, the helically-disposed electrically conducting elements are current collectors, such as conducting metal meshes, which may form the electrode, of the flexible leaf/leafs. The outside end of the current collectors are then further secured in conductive electrical contact to the primary busbar conducting clement that is located outside of the spiral-winding, external to the spiral-wound cell. In this embodiment there is no secondary busbar between the electrode in the flexible leaf/leafs and the primary busbar external to the spiral-winding.

Embodiments include methods for forming the electrical connection between the flexible electrode leaf and the module. These are preferably, but not exclusively, achieved by one of the means described below:
i. “External Spiral Attachment”: In one example the electrode of the flexible leaf is directly welded, soldered, glued with conductive glue, or otherwise attached in conductive electrical contact to a primary busbar located at, and running down part or all of the length of the external element. The primary busbar may be located within the external element, or it may be attached to the outside of the external element. FIG. 4(b) illustrates the External Spiral Attachment method.
ii. “External Spiral Busbar Attachment”: In another example, the flexible electrode leaf is welded, soldered, glued with conductive glue, or otherwise attached in conductive electrical contact to a secondary busbar, which is disposed across the flexible electrode, in the direction of spiral-winding. The unattached end of the secondary busbar is then welded, soldered, glued with conductive glue, or otherwise attached in conductive electrical contact to a primary busbar located at, and running down all or part of the length of the external element. The primary busbar may be located within the external element, or it may be attached to the outside of the external element. FIG. 5(b) illustrates the sternal Spiral Busbar Attachment method.

### D. General Methods of Spiral-Winding—Permutations and Combinations of Gas/Liquid Plumbing and Electrical Connections

It is to be understood that, without limitation, all combinations, permutations, or arrangements in which one or more of the above methods of gas/liquid plumbing is used in concert with one or more of the above methods of electrical connection to create a spiral-wound cell, fall within the scope of the present invention. The present examples are illustrative only and do not limit the invention in any way.

Moreover, it is to be understood that it is not necessarily the case that the components of a spiral-wound all are individually formed or provided as a core element, end cap or external element. In some example cases, components may carry out functions that are a hybrid of two or more of the functions of the described core element, end cap or external element. For example, an end cap(s) may be integrally formed as part of the core element or the external element. In other example cases, a component may be either an external element or an end cap, or neither. In these cases, it is to be understood that all combinations, permutations or arrangements in which one or more of the above arrangements or methods of gas/liquid plumbing and/or one or more of the above arrangements or methods of electrical connection to create a spiral-wound cell, fall within the scope of the present invention regardless of whether or not the specific components involved can be clearly identified as belonging to a particular class of element.

It is further to be understood that not all classes of element are required in a spiral-wound cell. For example, end caps or external element may not be needed. Similarly, a core element may not be required.

The following examples provide a more detailed discussion of particular embodiments. The examples are intended to be merely illustrative and not limiting to the scope of the present invention.

### Example 1

### Gas/Liquid Plumbing through the Core Element Using the Conduit and Central Assembly Method

In the following example, we describe the method of plumbing a spiral-wound module referred to above as the “Conduit and Central Unit Assembly” Method.

In this method the conduit unit preferably but not exclusively, comprises one or more conduits down its length, each of which have an aperture or series of apertures connecting each conduit to the outside of the conduit unit. Preferably but not exclusively, one end of the leaf is sealed, glued, welded, or otherwise attached to the conduit unit in such a way that the aperture/s of at least one conduit in the conduit unit art in fluid communication with the gas/liquid channels within the leaf.

Preferably but not exclusively, the conduit unit is sealed, glued, welded, or otherwise attached within the gas/liquid channel of the flexible electrode leaf. By this is meant that the upper and lower portions of the leaf are sealed, glued, welded, or otherwise attached to the upper and lower portions of the conduit respectively, to thereby seal the conduit into the gas/liquid channel of the flexible electrode leaf. The conduit unit preferably but not exclusively, has a shape that is complementary to the central unit, so that once the conduit unit and the central unit are sealed, glued, welded, or otherwise attached to each other, they form as cylindrical core element.

In one set of embodiments, one or more conduit units may form portions of a cylinder, with the central unit forming the remainder of the cylinder, such that when the central unit is sealed, glued, welded, or otherwise attached to one or more conduit units, the resulting, core assembly comprises a cylinder. Non-limiting examples of such embodiments include:
(1) The “Profile Needle” design
(2) The “Glued Wedge” design

Embodiments illustrating these designs are presented in the next example.

### Example 1a

### Gas/Liquid Plumbing through the Core Element Using the Conduit and Central Assembly Method Applied to the Profile Needle Glued Wedge Design

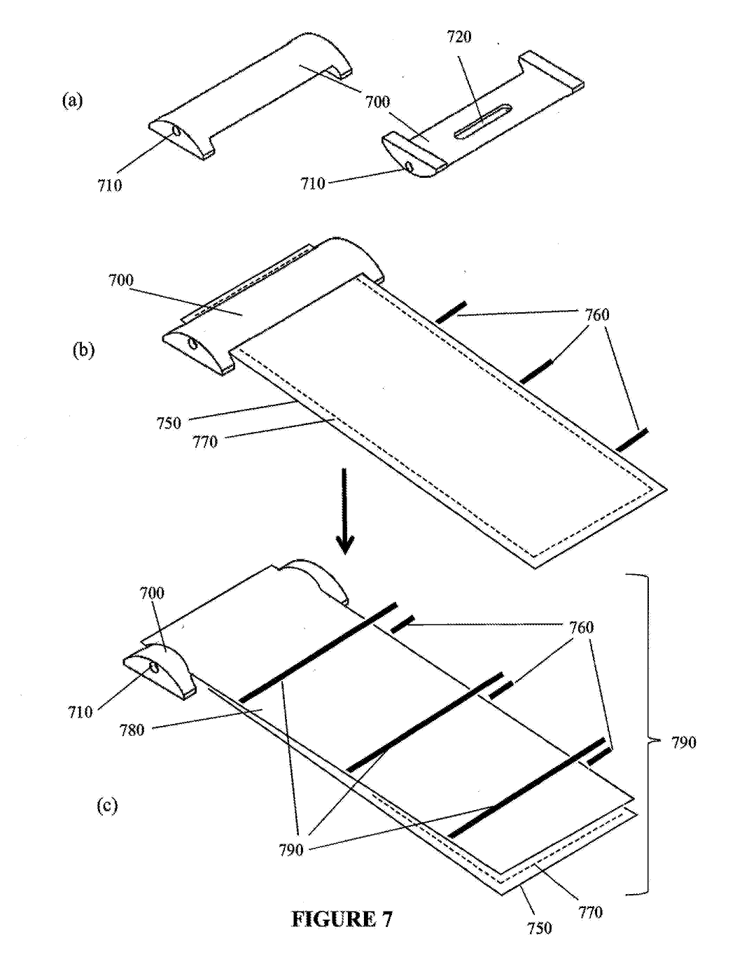

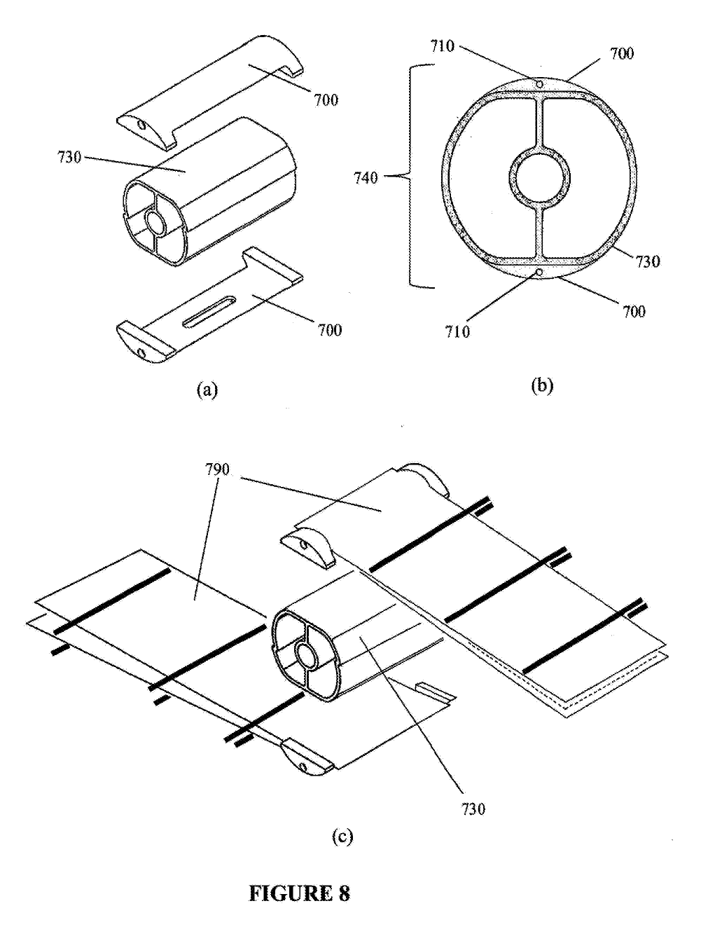

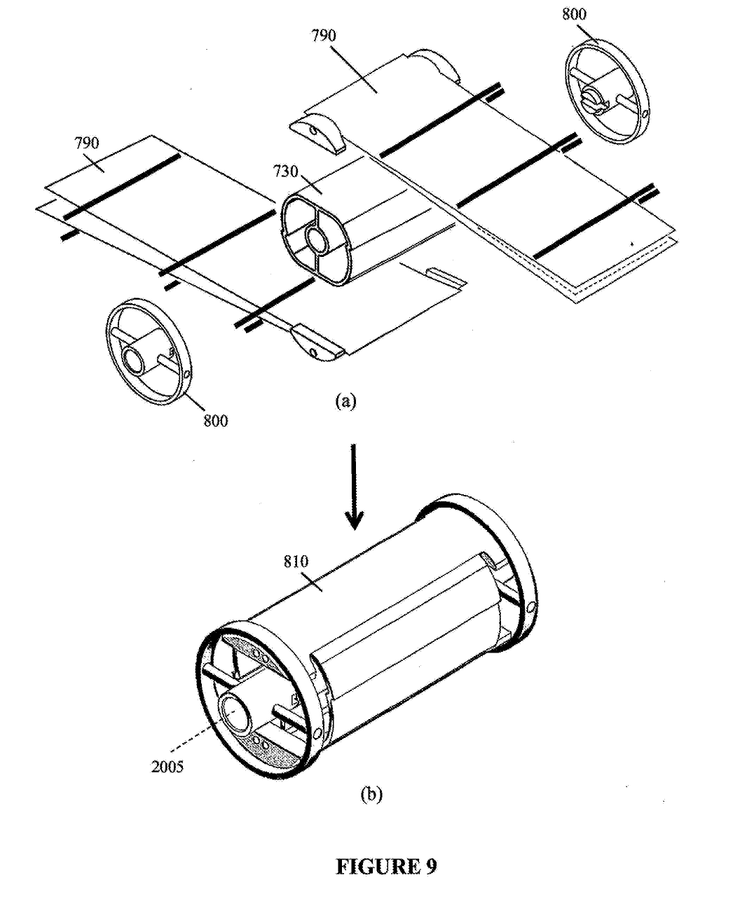

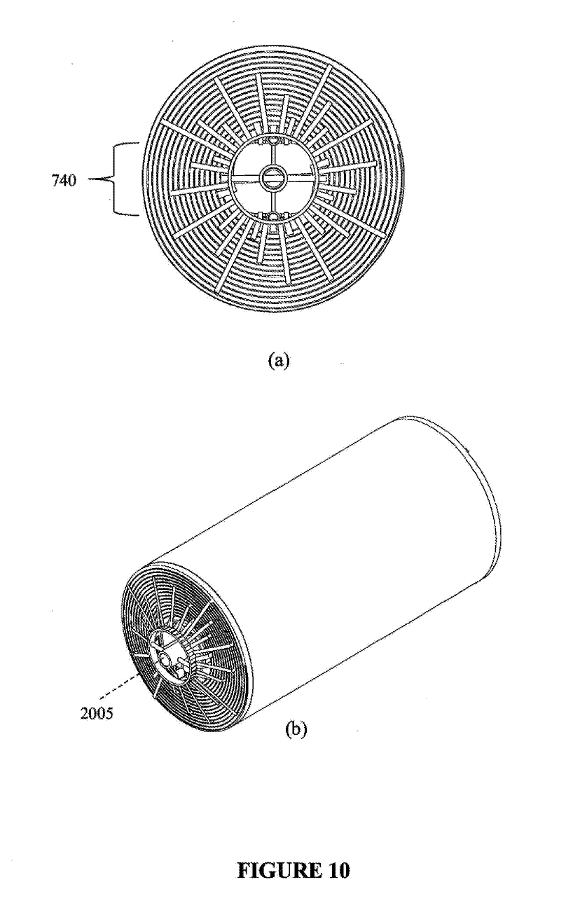

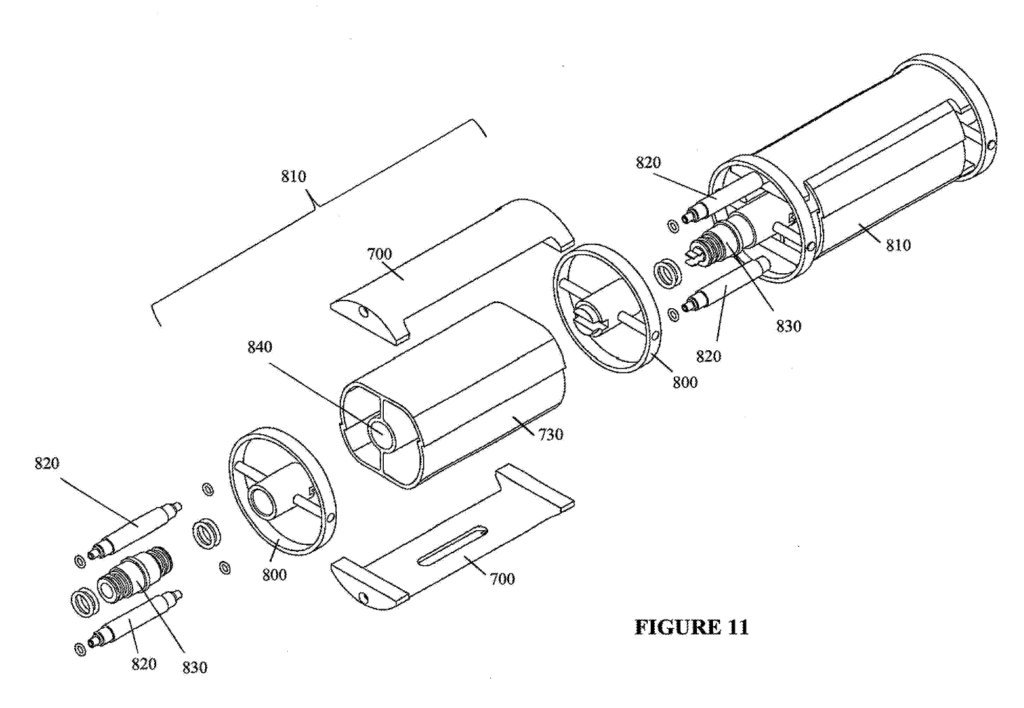

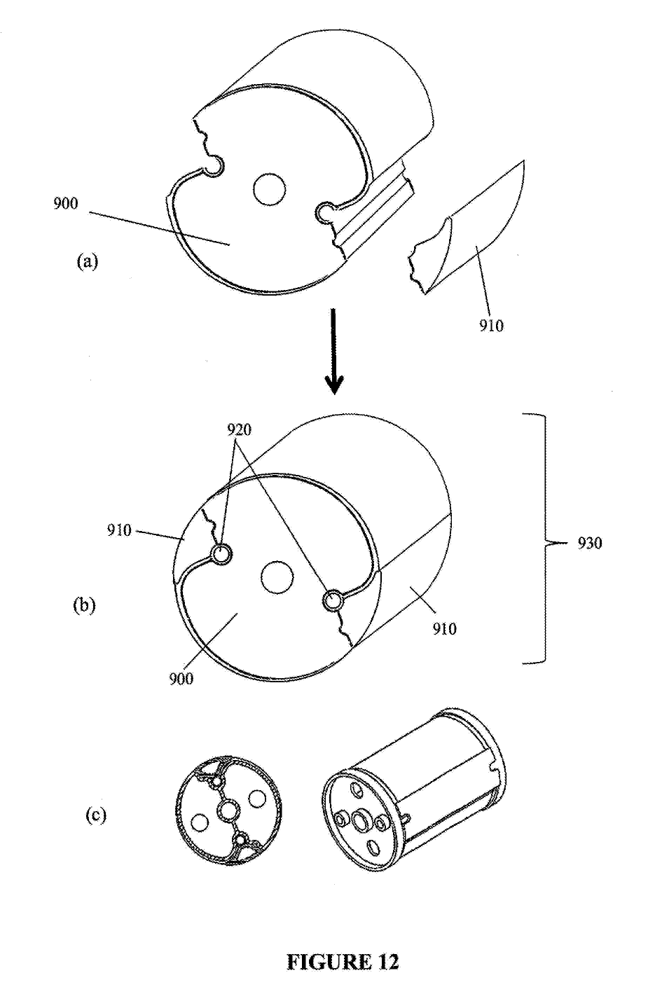

FIG. 7, FIG. 8, FIG. 9, FIG. 10, and FIG. 11 illustrate the assembly of a spiral-wound module using the so-called Profile Needle design.

As depicted in FIG. 7(a), a Profile Needle 700 is a fitting that is half-rounded on its upper surface and substantially flat on its lower surface. The center of the Profile Needle contains a hollow tube that starts at the external aperture 710 on its side and traverses the length of the Profile Needle, opening up at its bottom in the cavity 720. The tube 710-720 down the length of the Profile Needle 700 is a “Conduit” in the terminology of this specification. The Profile Needle 700 is a “Conduit Unit”, as that is defined in this specification.

As depicted in FIG. 8(a), two Profile Needle units 700 are designed to be assembled with a “Central Unit” 730, to form a cylinder-like core element 740. FIG. 8(b) illustrates, in cross-section, the core element 740 after the assembly of the two Profile Needles 700 and the central unit 730. Comprising as it does, of two conduit units 700 and one central unit 730, this assembly process is an example of the “Conduit and Central Assembly” method for creating a core element 740 that was described earlier. Before assembling the core element 740, the Profile Needle 700 is used to plumb the gas/liquid channels in a flexible electrode. This process is illustrated in FIG. 7(b)-(c).

In the first step shown in FIG. 7(b), a single flexible electrode 750, optionally with secondary busbars 760 present, is glued to the bottom of the Profile Needle unit 700, with the non-conductive side of the flexible electrode facing the Profile Needle unit. A porous spacer 770, whose outer edges are shown by the dotted line in FIG. 7(b), is interposed between the back of the breathable electrode and the back of the Profile Needle unit. Spacers of this type are typically polymer nets of the example type manufactured by Hornwood or Delstar Inc. Example spacers can be made at least partially or wholly from a polymer material, for example PTFE, polyethylene or polypropylene.

In the second step depicted in FIG. 7(c), a second breathable electrode 780 with its secondary busbars 790, is glued over the top of the Profile Needle unit 700 and the first breathable electrode 750 and spacer 770, with its back facing the Profile Needle unit and the first breathable electrode 750 and spacer 770. Once the assembly 790 in FIG. 7(c) has been sealed with glue or by welding (e.g. ultrasonic welding) around its edges, then the electrode channel between the two electrodes 750 and 780, which contains the porous spacer 770, is now sealed to the Profile Needle unit 700 in such a way that it is in fluid communication with the conduit 710-720 in the Profile Needle 700. That is, the only exit entrance into the electrode channel between the two electrodes 750 and 780, is via the aperture 710 in the Profile Needle 700.

To assemble the spiral-wound module, two such Profile Needles with attached leafs 790 are combined with the central unit 730, as depicted in FIG. 8(c). Typically the parts 790 are fixed to the central unit 730. Thereafter, another spacer—a flow-channel space—is introduced between the two attached leafs and the assembly is wound (in an anti-clockwise direction in this ease), causing the leafs to form a spiral-wound structure.

The resulting spiral-wound cell has now been plumbed such that the two channels in the flexible electrode (one a cathode channel and the other an anode channel) are each sealed in fluid communication with a separate conduit located in a separate conduit unit, which form part of the core element. Liquid or gaseous reactants for the respective electrodes may be separately introduced into each channel via the aperture on its Profile Needle fitting. Similarly, the liquid or gaseous products of each electrode may be collected from the electrode channel via the aperture on its Profile Needle fitting.

This approach may be extended to the use of 4, 6, 8 or more flexible leafs. Creation of the electrical connections for each of the flexible leafs is discussed in Example 2a. The key advantage of this approach to spiral-wound electrochemical cells is that the flexible leafs and their constituent electrode channels can be readily, practically and inexpensively plumbed during the assembly of the core element.

A similar approach to plumbing of the flexible leafs through the core element makes use of the Glued Wedge design depicted in FIG. 12(a)-(b). In this case, a central unit 900 has wedged-shaped excisions from its opposite sides. When then assembled with the complementary-shaped wedges 910 into a single core element 930, then two conduits 920 are formed down the length of the core element. The wedges 910 are specially shaped to allow for a flexible leaf to be glued or welded into the central unit 900 such that its open end lies inside the conduit 920, with the wedge 910 then glued or welded on top of the attached leaf. The final assembled unit, with the spiral-wound leafs left off for clarity, is depicted in FIG. 12(c).

### Example 2

### Electrical Connection through an End Cap Using the Axial Attachment and the Axial Busbar Attachment Method

The electrical connections of the flexible electrode leaf or leafs in a spiral-wound cell may be conveniently brought together, collected, accumulated, or gathered into a single electrical connection by utilizing electrically conducting elements in the end cap of a spiral-wound cell. In one aspect, the end-cap contains a primary busbar for the cell, to which all of, either, the anodes or the cathodes in the cell are electrically connected. In one embodiment, all of the anode electrodes or all of the cathode electrodes in the flexible electrode array are directly welded, soldered, or otherwise securely attached in conductive contact to the primary busbar on the end cap. This method of electrically connecting a spiral-wound module is known as the “Axial Attachment” Method.

A variant on the Axial Attachment method is the Axial Busbar Attachment method, which involves welding, soldering, or otherwise conductively attaching secondary busbars, disposed perpendicularly to the direction of spiral winding, to the electrodes in the flexible sheets, and then welding, soldering or otherwise conductively attaching the other ends of the secondary busbars to the primary busbar in the end cap.

While several configurations may be envisaged for the attachment of the busbars, a preferred but not exclusive embodiment involves welding, soldering, gluing with conductive glue, or otherwise conductively attaching 5-10 mm wide metal strips of thickness 0.25 mm, at intervals of 5 cm down the length of the flexible electrode sheet.

In order to separately connect the anodes and cathodes in the flexible electrode array, a preferred embodiment involves conductively attaching all of the anodes to a primary busbar at one end-cap and all of the cathodes to a primary busbar at the other end-cap, as depicted in FIG. 6. To facilitate this, all of the anode busbars may be allowed to extend beyond the anode channels in the flexible sheet toward one end cap, while all of the cathode electrodes are allowed to extend beyond the cathode channels in the flexible sheet toward the other end cap. The extended ends of the anode electrodes are then welded, soldered or otherwise conductively attached to the primary busbar in the one end cap and the extended ends of the cathode electrodes are then welded, soldered or otherwise conductively attached to the primary busbar in the other end cap.

This is illustrated in the Profile Needle and Glued Wedge Designs.

### Example 2a

### Electrical Connection through an End Cap Using the Axial Attachment and the Axial Busbar Attachment Method Applied to the Profile Needle/Glued Wedge Design

An example illustrating electrical connection made via the end caps is provided in the Profile Needle case described above. To create the electrical connection of each of the electrodes, a conductive element may be incorporated into the end caps. FIG. 9(a) illustrates how two end caps 800, each of which comprises of a conducting primary busbar, which is typically a metal such as nickel, may be added to the assembly of the Profile Needles and leafs 790 and the central unit 730. The protruding ends of the busbars on each leaf, would typically be welded to the endcap primary busbar 800 that is closest to them. The busbar would then provide the external electrical inlet/outlet that connects the flexible leafs in the spiral-wound array. One busbar would electrically connect all of the anodes and the other would connect all of the cathodes, according to the principle of Asymmetric Electrical Connection depicted in FIG. 6.

FIG. 9(b) depicts the final assembled spiral-wound module centered on central axis 2005, which is the longitudinal axis of the module or cell, with the spiral-wound leafs and their busbars not shown for clarity. As can be seen, after assembly, the primary busbars in the end caps 800 are designed to be located proximate to the protruding ends of the secondary busbars on each wound leaf, to thereby greatly simplify the welding of the leaf secondary busbars to the end cap primary busbar.

Following assembly of the resulting spiral-wound cell, it would typically be encased in a polymeric casing. FIG. 10 depicts a spiral-wound cell encased in polymer, shown relative to central axis 2005. FIG. 10(a) shows an end view of the polymer easing that goes over the axial ends of the spiral-wound assembly. Liquid or gases would typically be able to pass through the polymer easing at the axial ends of the module and move through the inter-electrode channels in the spiral-wound module.

Another feature of this approach is that multiple modules may be combined in linear arrays. FIG. 11 depicts bow that may be achieved. A module 810 is combined with another module 810, with two “quickfit” gas/liquid connectors 820—one for the anode gas/liquid channel and the other for the cathode gas/liquid channel—as well as with an electrical connector 830, with provides for several electrical configurations via the central tube 840 within the core element.

The advantages inherent in this approach to spiral-wound electrochemical cells includes the fact that the flexible leafs can be virtually any length, since the presence of the secondary busbars and their location proximate to the primary busbar after spiral winding, means that problems associated with electrical resistance and even current distribution over the sheet electrodes may be readily managed. Further embodiments illustrating the Axial and Axial Busbar Attachment methods are provided in the Tricot Pack, and Syringe Needle design examples (Example 3a and Example 4a).

### Example 3

### Gas/Liquid Plumbing through the Core Element Using the Direct Attachment Method

In the following example, we describe the method of plumbing a spiral-wound module referred to above as the “Direct Attachment” Method. In this method, preferably but not exclusively, the core element is pre-fabricated and provided as a single cylindrical or cylinder-like unit containing at least one conduit down its length, each of which conduits has an aperture or series of apertures connecting the conduit to the outside of the core element. The leaf or leafs are then sealed, glued, welded, or otherwise attached to the core element in such a way that the aperture/s of the at least one conduit in the core element is/are in fluid communication with the gas/liquid channels within the leaf associated with that conduit.

In one set of embodiments, preferably but not exclusively, the leaf is sealed, glued or otherwise attached to the core unit by wrapping, it around the core unit in such a way that its gas/liquid channel opens out to a volume immediately above or near to the aperture's of its relevant conduit in the core element. By this means, the conduit, via its aperture/s, is brought into fluid communication with the gas/liquid channels within the leaf. Non-limiting examples of such embodiments include:
(1) The “Tricot Pack” design.

An embodiment illustrating this design is presented in the next example.

In another set of embodiments, the conduit is fabricated to comprise at the outer surface of the core element, one or more external lipped or flanged apertures into which an end of a leaf may be readily inserted for example down or along the full length of the core element), such that its gas/liquid channel opens out into the conduit or opens out to a volume immediately above or near to the aperture/s of its relevant conduit in the core element. The leaf is then sealed, glued, welded, or otherwise attached in such a way that the ape of the conduit is/are in fluid communication with the gas/liquid channels within the leaf. Non-limiting examples of such embodiments include:
(1) The “Wedge Glue” design.

Embodiments illustrating this design are presented in Examples 6a-6c below.

In another set of embodiments that involve apertures, which may optionally be lipped or flanged, the core element may contain a hollow, substantially hollow, or somewhat hollow cylinder-like structure all or part of the way down its length, where the conduits are designed to be created within the hollow, substantially hollow, or somewhat hollow portions of the cylinder-like structure. The leaf is then inserted (for example down or along the full length of the core element), such that its gas/liquid channel opens out into the hollow which is designed to create the conduit or it opens out to a volume immediately above or near to the hollow which is designed to create the conduit. The hollow, containing the end of the inserted leaf, is then filled with a potting resin leaf down its full length. The potting resin is allowed to cure. Preferably but not exclusively, the thereby sealed resin-filled hollow is then drilled out using a suitable (larger diameter) drill bit capable of traversing the entire length of the resin-filled hollow. In so doing, the sealed end of the gas/liquid channel, of the leaf that is located within the hollow, is opened up to, and placed in unobstructed liquid/gas communication with the conduit that is created by the action of the drill bit. The hole down the full length of the resin-filled hollow, thereby creates a conduit which incorporates the open end of the gas/liquid channel of the leaf. In this way, the conduit is brought into fluid communication with the gas/liquid channels within the leaf. Non-limiting examples of such embodiments include:
(2) The “Potted Plumbed” Design
(3) Two-Leaf “Conductive Potted Plumbed” Design
(4) Multi-Leaf “Conductive Potted Plumbed” Design

Embodiments illustrating these designs are presented in Example 6d below. In order to illustrate the concept involved in the Direct Attachment method, we now describe its application to the Tricot Pack design.

### Example 3a

### Gas/Liquid Plumbing through the Core Element Using the Direct Attachment Method Applied to the Tricot Pack Design

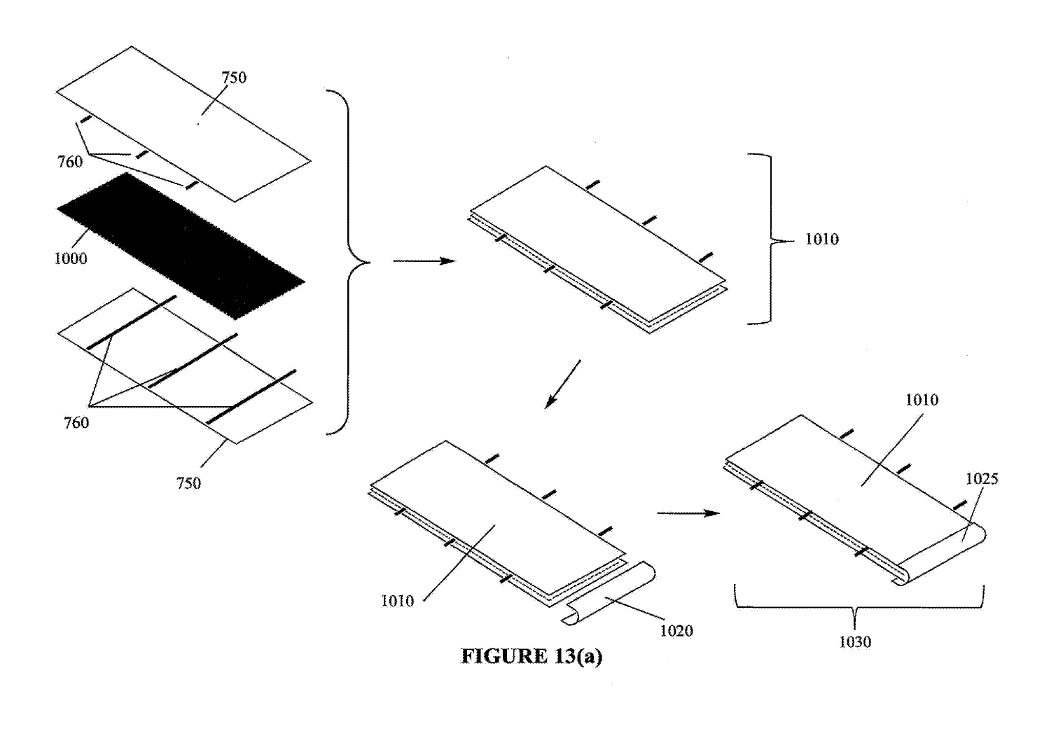

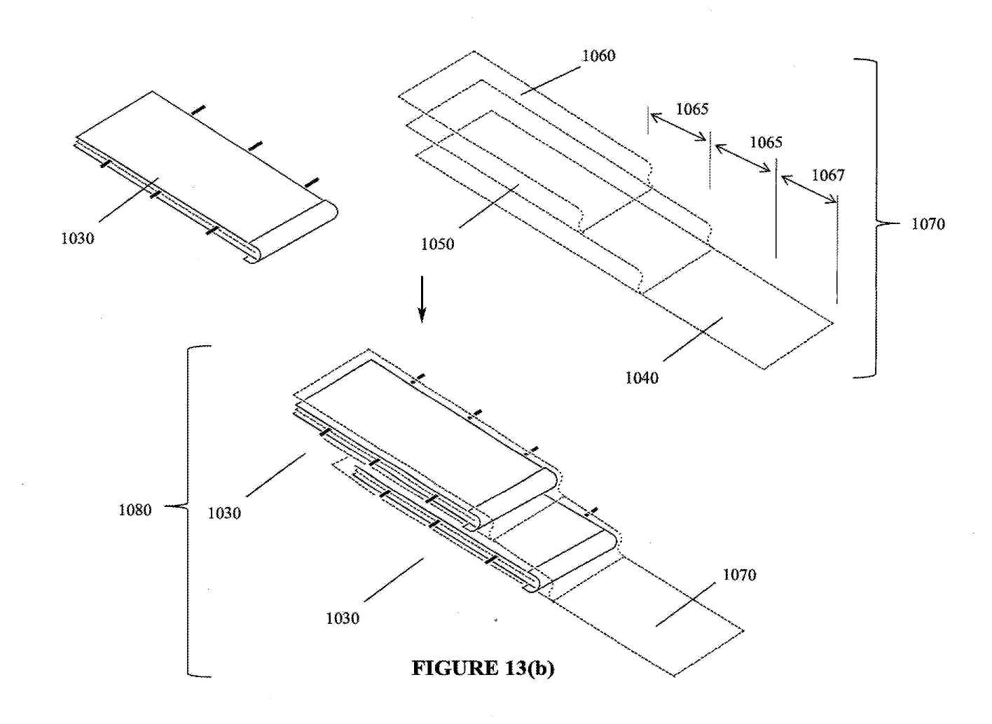

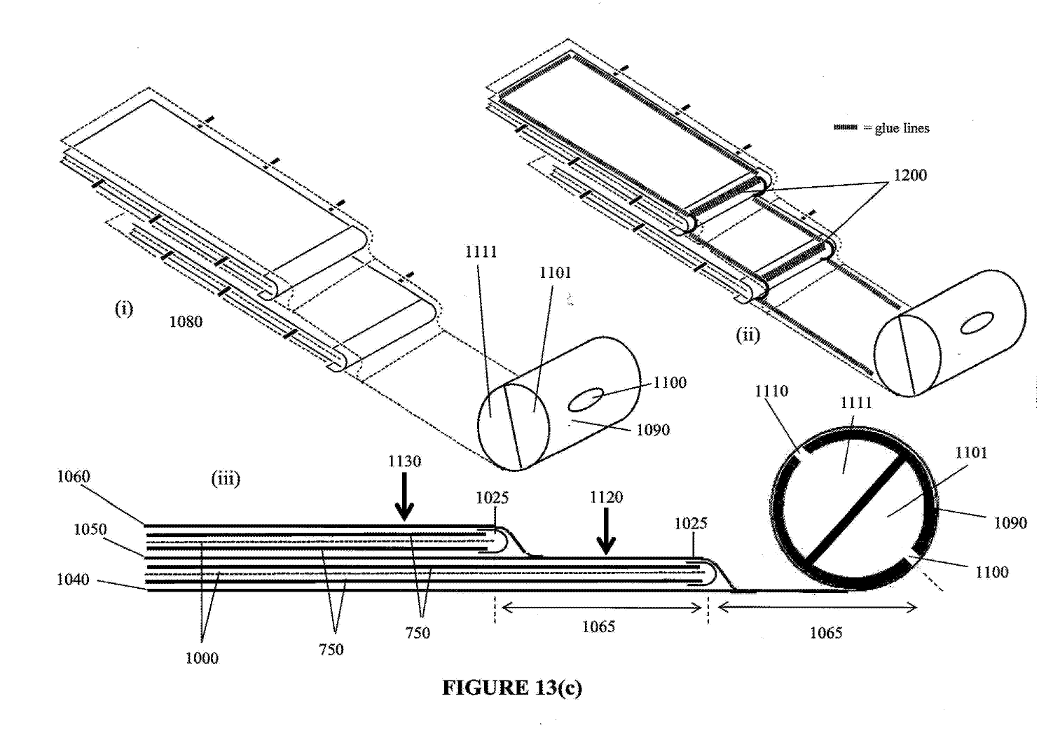

FIG. 13(a)-(c) depicts the fabrication of a 2-leaf spiral-wound cell using the so-called “Tricot Pack” design. Two flexible leafs 760 (Anode) and 760 (Cathode) are assembled with an inter-electrode spacer 1000 to form a multi-leaf unit 1010 as shown in FIG. 13(a). Spacers 1000 of the type shown are typically polymer nets manufactured by Hornwood or Delstar Inc. Example spacers can be made at least partially or wholly from a polymer material, for example PTFE, polyethylene or polypropylene. The spacer 1000 must be present between the two electrodes, to prevent electrical shorting. One end of the multi-leaf unit 1010 is now closed off using a non-conductive membrane known as a “bandage” 1020. The membrane would typically be the same material as the non-conductive substrate in the flexible leafs. The bandage would typically be securely welded or glued to the upper side (the bottom) of the anode at its one end and the lower side (the bottom) of the cathode at its other end. The securely attached bandage 1025 will seal off the end of the assembly 1030.

In alternative embodiments, a single leaf may be folder to form the assembly 1030, provided only that the area where the bandage would normally go is non-conductive and does not lead to a short-circuit between the facing anode and cathode. In another alternative, the anode and cathode leafs may be directed welded to each other provided that the electrodes on the leafs do not extend to the point at which the leafs are attached to each other. FIG. 13(b) depicts the creation of a 2-leaf Tricot Pack. A set of three spacers 1040, 1050, and 1060 are used to create the framework for the Tricot Pack. The spacers would typically be polymer nets manufactured by Hornwood or Delstar Inc.

The spacers are attached to each as shown in FIG. 13(b) (top right), were a fixed interval 1065 is left between the connections. That is, spacer 1050 is attached a distance 1065 from a particular point near the end of spacer 1040. That point is separated from the end of the spacer by another distance 1067. Spacer 1060 is then attached at the same distance 1065 away from the attachment point of spacer 1050. For a 2-leaf spiral-wound module, the distances 1065 correspond to half a circumference of the core element to be used, while the distance 1067 corresponds to two circumferences of the core element.

Once the framework of spacers 1070 is created, two end-sealed electrode assemblies 1030 are inserted into the framework 1070. The first electrode assembly is fitted in the space between spacers 1040 and 1050 as shown in FIG. 13(b) (bottom). The second electrode assembly 1030 is fitted in the space between spacer 1050 and 1060, as shown in FIG. 13(b) (bottom). The resulting assembly 1080 is known as a “Tricot Pack”.

The Tricot Pack is now ready to be rolled onto is pre-existing core assembly 1090, which comprises of a tube divided into two chambers 1101 and 1111, each having apertures to the outside, 1100 and 11101, respectively. As the Tricot Pack is directly attached to the core element, the method of forming the spiral-wound module is the Direct Attachment method. The end of the spacer 1040 in the Tricot Pack 1080 is glued or welded to the core element at a point precisely between the apertures 1110 and 1100. Glue lines are then applied as shown in FIG. 13(c)(ii).

The Tricot Pack is now tensioned and rolled onto the core element 1090. The distances 1065 and 1067 ensure that, when rolled up, the spacer 1040 rolls onto the core element first, for two revolutions. Thereafter, spacer 1050 and 1040 are rolled onto the core element, with the aperture 1110 lining up to fall at point 1120 shown in the cross-sectional view in FIG. 13(c)(iii). Thereafter spacers 1040, 1050, and 1060 all roll on the core element with aperture 1100 lining up to fall at point 1130. The point 1120 corresponds to the anode channel in the spiral-wound assembly. The point 1130 corresponds to an entrance to the cathode channel. The glue lines 1200 separate and demarcate the anode and the cathode channels in the spiral-wound module, from each other.

It should be noted that the anode secondary busbars 760 (Anode) and the cathode secondary busbars 760 (Cathode) lie on opposite sides of the spiral winding. As described in Example 2a, an end cap containing a primary busbar may be attached to each end of the spiral-wound multi-leaf assembly. The secondary busbars may then be welded, soldered, or otherwise conductively attached to their closest primary busbar, to thereby establish the electrical connections. The advantage of the Tricot Pack design is that it may be rolled up from one side only. This simplifies and speeds the fabrication of the spiral-wound cell. Moreover, it is amenable to the attachment of multiple leafs to a single core element.

### Example 4

### Gas/Liquid Plumbing through the Core Element Using the Conduit Unit Assembly Method

In the following example, we describe the method of plumbing a spiral-wound module referred to above as the “Conduit Unit Assembly ”Method. In this method, preferably but not exclusively, the conduit is fabricated within a stand-alone unit, to which one end of the leaf is sealed, glued, welded, or otherwise attached in such a way that the aperture/s of the conduit is/are in fluid communication with the gas/liquid channels within the leaf. One or more conduit units, with their attached leafs are then sealed, glued, welded, or otherwise attached together, to thereby create the core element out of the combined stand-alone conduit units each of which, has their leaf attached).

Preferably but not exclusively, the conduit unit is sealed, glued, welded, or otherwise attached within the gas/liquid channel of the flexible electrode leaf. By this is meant that the upper and lower portions of the leaf are sealed, glued, welded, or otherwise attached to the upper and lower portions of the conduit respectively, to thereby seal the conduit into the gas/liquid channel of the flexible electrode leaf. The conduit unit preferably but not exclusively, has a shape that is complementary to itself, as to thereby facilitate the assembly of the conduit units into a cylinder-like core element.

In one set of embodiments, one or more conduit units, with their attached leafs, are combined together with suitable spacers between then to prevent short circuits and then wound in a spiral about a central tube, which has no purpose other than to provide a base for the spiral-winding. Non-limiting examples of such, embodiments include:
(1) The “Syringe Needle” design

An example illustrating this design is presented in the next example. In another set of embodiments, one or more conduit units, with their attached leafs, are assembled together into a form that is held together by a scaffold material in a cylinder-like structure. The leafs are then spiral-wound around the cylinder-like structure. Non-limiting examples of such embodiments include:
(1) The “Rolodex” design

An example illustrating this design is presented in the next example.

### Example 4a

### Gas/Liquid Plumbing through the Core Element Using the Conduit Assembly Method Applied to the Syringe Needle and Rolodex Designs

The Syringe Needle design is distinguished from the Profile Needle design by the fact that a plain tube, such as a perforated metal tube, is used as the conduit for plumbing the channel within a spiral-wound flexible leaf. Moreover, the use of the Conduit Assembly method means that the core element is created by the simple combination of the plumbing tubes. To facilitate the external connection of the tubes that then form the core element, it is often advantageous to have a luer lock of the type used on syringe needles on one end of the tube, hence the name Syringe Needle design.

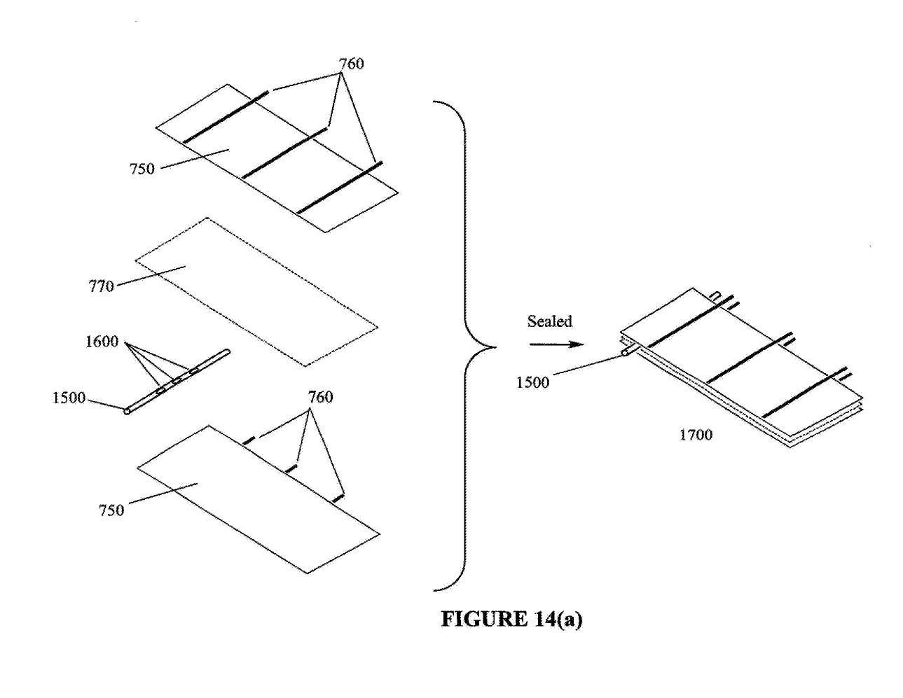

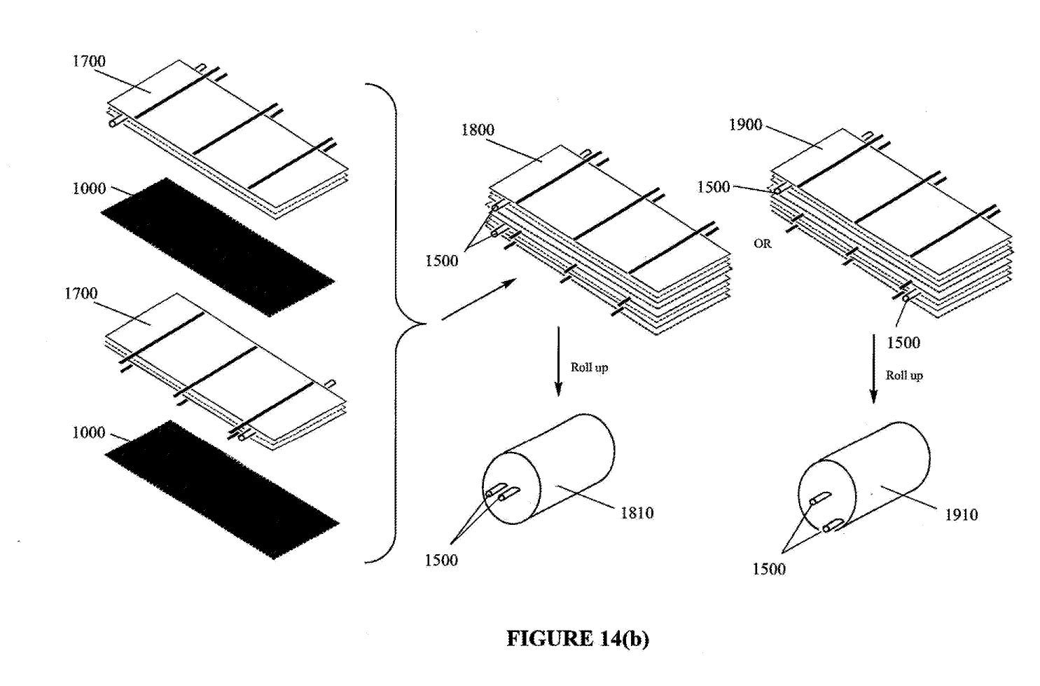

FIG. 14(a)-(b) illustrates this method of plumbing a spiral-wound cell. As depicted in FIG. 14(a), two flexible electrode leafs 750, with their secondary busbars 760 are combined with a gas/liquid spacer 770 and a stainless steel tube 1500 having perforations 1600 down its length, arc combined such that the conductive electrodes of the leafs are facing outwards. The assembly is then sealed using welding or by gluing its edges, to form to sealed electrode unit 1700 whose internal channel can only be accessed through the two ends of the incorporated stainless steel tube 1500.

FIG. 14(b) shows how the spiral-wound assembly is created. Two such sealed electrode units 1700—one to function as an anode and one to function as to cathode—are assembled with two flow-channel spacers 1000. The combination, can either have the two incorporated tubes at the same end, giving cell 1800, or the incorporated tubes can be at opposite ends, giving cell 1900.

When cell 1800 is rolled up, starting at the end containing the tubes, a spiral-wound cell, module or assembly 1810 is formed where the incorporated tubes form a core element of sorts. By this means, a spiral-wound cell, module or assembly 1810 of flexible electrode leafs is created in which the anode channels are plumbed through one incorporated stainless steel tube and the cathode channels are plumbed through the other incorporated tube.

Primary busbars may be attached as end caps and the secondary busbars on each of the anode and cathode may be welded, soldered or otherwise conductively attached to their nearest primary busbar to effect the electrical connections.

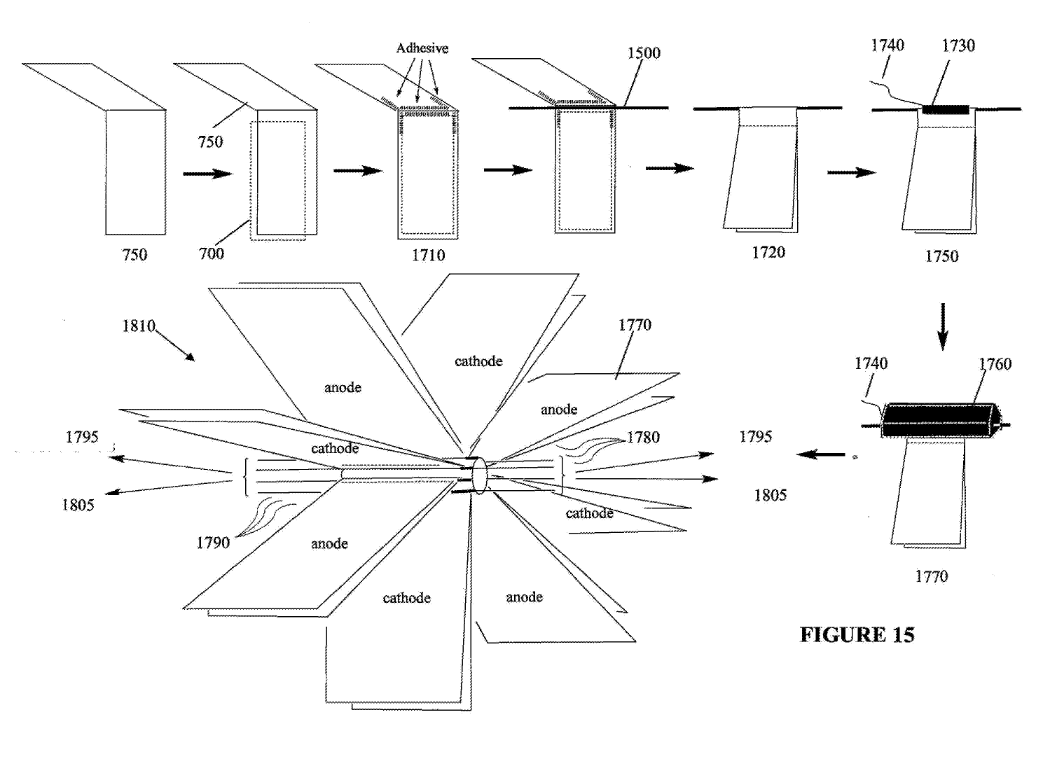

The advantage of the Syringe Needle design is that it minimises the number of sealed edges, thereby reducing the possibility of leaks through those sealed edges. Another design that makes use of the Conduit Assembly method is the so-called Rolodex design. FIG. 15 illustrates the steps involved in assembling a spiral-wound module using that design. A flexible electrode leaf 750 is folded in half, such that the conductive side of the flexible leaf is on the outside of the fold, with the non-conductive substrate on the inside. A gas/liquid spacer 700 is then placed on the inside of the folded leaf and adhesive is applied as shown in assembly 1710. Thereafter, a stainless steel tube 1500 with perforations is incorporated in the fold of the leaf. The leaf is then turned over and sealed along the adhesive lines as shown in assembly 1720.

At this stage, conductive busbar clip 1730 is placed over the outside of the fold. The busbar clip 1730 electrically attaches to the electrode in the flexible leaf 750, and provides an electrical wire 1740 through which the flexible electrode may be connected. The next step involves “potting” the electrical connection and the folded portion of the leaf using a potting resin. This is typically achieved by placing the busbar and glued, folded portion of the leaf assembly 1750 into a V-shaped casting box and then filling the box with the potting resin. Once the resin has cured, the entire busbar clip and folded portion of the leaf is encapsulated within a shaped resin 1760.

The potted resin 1760 is typically shaped so as to allow a collection of potted leafs 1770 to be easily assembled into a core element with leafs. Assembly 1810 depicts the combination of eight potted leafs 1770 into a core element with attached leafs. The potted leafs 1770 are typically assembled in alternating fashion as shown in 1810, so that the electrical connections 1740 for half of them are aggregated on the left-hand side of the core element, as depicted at 1790, and the other half will be aggregated on the right-hand side of the core element, as depicted at 1780. The eight stainless steel tubes in the assembled core element alternate between anode channels and cathode channels; they may each be aggregated into a single inlet/outlet fitting. Gas/fluid flow is illustrated schematically from/to anode channels 1795 and cathode channels 1805.

In the final step of the assembly, which is not shown in FIG. 15, each set of leafs in 1810 are welded or glued together around their edges to thereby seal their respective anode or cathode channels. Flow channels spacers are then placed between each set of leafs, and the entire assembly is then wound up into a spiral-wound arrangement. The advantage of the Rolodex design is that it provides superior sealing and strength around the tube that plumbs each flexible leaf. The plumbing fittings for individual leafs are typically the most susceptible places at which leaking may occur.

### Example 5

### External Gas/Liquid Plumbing Using the External Conduit Method

In the following example, we describe the method of externally plumbing a spiral-wound module referred to above as the “External Conduit” Method.

In this method, preferably but not exclusively, the conduit is fabricated within a stand-alone unit, to which one end of the leaf/leafs is sealed, glued, welded, or otherwise attached in such a way that the aperture/s of the conduit is/are in fluid communication with the gas/liquid channels within the leaf. The leaf/leafs are then spiral-wound in such a way that the conduit unit then becomes located on the outside of the spiral-wound module, and external to the spiral-wound cell.

Preferably but not exclusively, the conduit unit is sealed, glued, welded, or otherwise attached within the gas/liquid channel of the flexible electrode leaf. By this is meant that the upper and lower portions of the leaf are sealed, glued, welded, or otherwise attached to the upper and lower portions of the conduit respectively, to thereby seal the conduit into the gas/liquid channel of the flexible electrode leaf.

The leaf is then combined with other leafs, separated by suitable spacers that avoid the possibility of short circuits between the electrodes, and wound into a spiral in such a way that the conduit unit is left on the outside of the spiral—that is, it becomes located external o the spiral-wound cell.

An example of this approach is provided in FIG. 14(b), which depicts an anode—cathode cell 1900 that has been assembled with the plumbing tubes at opposite ends of the leaf. When cell 1900 is rolled up, one of the plumbing tubes becomes located in the center of the spiral-winding, forming a core element of sorts, while the other plumbing tube becomes located on the outside of the spiral-winding, forming an external element of sorts, as depicted in spiral-wound cell, module or assembly 1910.

In another set of embodiments, the conduit unit is fabricated to comprise at its outer surface, one or more external aperture which may be lipped or flanged, and into which an end of a leaf may be readily inserted (for example down or along the full length of the conduit unit), such that its gas/liquid channel opens out into the conduit or opens out to a volume immediately above or near to the aperture/s of its relevant conduit in the core element. The leaf is then sealed, glued, welded, or otherwise attached in such a way that the conduit is in fluid communication with the appropriate gas/liquid channels within the leaf.

In still another set of embodiments that involve apertures, which may optionally be lipped or flanged the conduit unit may take the form of a hollow, substantially hollow, or somewhat hollow structure, where the conduits are designed to be created within the hollow, substantially hollow, or somewhat hollow portions of the structure. The leaf is then inserted (for example down or along the full length of the conduit unit), such that its gas/liquid channel opens out into the hollow which is designed to create the conduit, or it opens out to a volume immediately above or near to the hollow which is designed to create the conduit. The containing the end of the inserted leaf, is then filled with a potting resin leaf down its full length. The potting resin is allowed to cure. Preferably but not exclusively, the thereby resin-filled hollow is then drilled out using a suitable (larger diameter) drill bit capable of traversing the entire length the resin-filled hollow. In so doing, the end of the gas/liquid channel of the leaf that is located within the hollow, is opened up to, and placed in unobstructed liquid/gas communication with the conduit that is created, by the action of the drill bit. The hole down the cull length of the resin-filled hollow, thereby creates a conduit which incorporates the open end of the gas/liquid channel of the leaf. In this way, the conduit is placed in fluid communication with the gas/liquid channels within the leaf.

### Example 6

### Electrical Connection through the Core Element Using the Internal Spiral Attachment Method

In the following example, we describe the method of electrically connecting a spiral-wound module, referred to above as the “Internal Spiral Attachment” Method. There is provided a convenient and efficient configuration, arrangement, or design for a core element of spiral-wound electrochemical cells, modules or reactors, such that the core clement is fabricated to incorporate at least one busbar (a ‘primary’ busbar) down its length for a flexible leaf of the multi-electrode array, and where the flexible leaf comprises of a sealed gas/liquid channel with its associated electrode or electrodes.

In another embodiment, the core element includes a conducting element provided lengthways along the core element. The conducting element may be a conducting or metallic wire, tube, strip, rod or the like. In one example, the conducting element is a busbar. In another embodiment, the flexible electrode is in electrical contact with the conducting element. Preferably, the flexible electrode is welded, soldered, glued with conducting glue, or otherwise conductively attached to the conducting element in the core.

In another example there is provided a core element for a spiral-wound electrochemical cell, the core element including at least one conduit provided lengthways along the core element. Also provided is an aperture provided lengthways along the core element and associated with the at least one conduit. The aperture is able to receive an end, or part of an end, of a flexible electrode, and the flexible electrode is able to be spiral-wound about the core element. Optionally, the core element can include a conducting element provided lengthways along the core element, and the conducting element can be a busbar. The received end, or part of the end, of the flexible electrode is in electrical contact with the conducting element.

In another example there is provided an end cap for a spiral-wound electrochemical cell, the end cap comprising gas and/or liquid channels, and wherein, the end cap is able to receive an end, or part of an end, of a spiral-wound flexible electrode.

In another example there is provided an end cap for a spiral-wound electrochemical cell, the end cap comprising electrical connection, wherein the end cap, is able to receive an end, or part of an end, of a spiral-wound flexible electrode.

The busbar can be positioned in an internal channel of the core element. Preferably, the busbar is a rod or wire of conductive material or metal. A conductive glue or resin can be used to electrically connect the flexible electrode to the busbar. An outer conductive surface of the flexible electrode can abut and electrically connect to the busbar. A conductive or non-conductive glue or resin can be used to attach the flexible electrode to the core element.

Optionally, the core element may contain multiple busbars, each insulated from each other, and each welded, soldered, glued with a conductive glue, or otherwise conductively attached to a different electrode—either anode or cathode in the flexible electrode array. Optionally, the multiple busbars in the core element may each be conductively attached to the electrodes that form a different gas/liquid channel in the flexible electrode array.

In another aspect, there is provided a core element for a spiral-wound electrochemical cell, the core element comprising: a conductive element associated with and located partly within at least one liquid/gas conduit provided lengthways along the core element; and, an aperture provided lengthways along the core element and associated with the at least one conduit and associated busbar; wherein, the aperture is able to receive an end from, or part of an end from, or gas from, or liquid from a flexible electrode, and where the inserted flexible electrode may be simultaneously welded to, soldered to, or otherwise securely attached in conductive electrical contact with the busbar, where the flexible electrode is able to be spiral-wound around the core element.

In another embodiment, the aperture is able to provide a lip to, or part of a lip to, or gas to, or liquid to a flexible electrode, where the flexible electrode is able to be spiral-wound about the core element, while the inserted flexible electrode is simultaneously welded to, soldered to, or otherwise securely attached in conductive electrical contact with the associated busbar.

The flexible electrode may be securely wedged in the aperture in electrical contact with the busbar during an insertion process. Additionally or alternatively the flexible electrode may be welded or soldered or otherwise electrically attached to the busbar. An example flexible electrode is a leaf having two conductive surfaces, layers or sheets on opposite faces of the flexible electrode.

In various examples the at least one conduit is a passageway, cavity or channel along an internal length of the core element. The at least one conduit can have an ellipsoidal or tear-drop shaped cross-section. The at least one conduit provides a gas or liquid communication channel. The core element can be fabricated from a polymeric material. Optionally, the aperture is lipped or flanged. Preferably, the aperture is located on an external surface of the core element. Optionally, the aperture or series of apertures is/are provided lengthways along part of the length of the core element.

Alternatively, the aperture is provided lengthways along the full length of the core element.

The core element may include two, four, six, eight or more conduits and two, four, six, eight or more apertures and be able to receive two, four, six, eight or more flexible electrodes. An insulating flexible spacer is positioned adjacent an electrode and the flexible electrode and the insulating flexible spacer are spiral-wound about the core element. The core element and spiral-wound electrode can be enclosed in a ease or housing.

Preferably but not exclusively, the leaf is inserted into the lipped or flanged aperture, causing the flexible electrode in the leaf to physically contact a busbar located down the length of the core unit within the conduit. In one embodiment, the flexible electrode may be made to become securely wedged in intimate contact with the busbar during the insertion process. In an alternative embodiment, the flexible electrode may be welded or soldered or otherwise securely attached in electrical contact to the busbar down or along the length of the flexible electrode, which may be the full length, before both the busbar and the attached leaf are inserted into the conduit.

Preferably but not exclusively, once the leaf electrode and the busbar are within the conduit and electrically connected to each other, then the connection between the electrode and the busbar are coated with an electrically conductive resin, down or along the length of the conduit, which may be the full length. In this way, the electrode(s) in the leaf become(s) securely and electrically connected to the busbar in the core element, down or along the length of the core element, which may be the full length.

In another set of embodiments that involve apertures, which may optionally be lipped or flanged, the core element may contain a hollow, substantially hollow, or somewhat hollow cylinder-like structure all or part of the way down its length, where the conduits are designed to be created within the hollow, substantially hollow, or somewhat hollow portions: of the cylinder-like structure. The hollow may have associated with it, a busbar down it length either fully or partly. Alternatively, a busbar may be introduced into the hollow. The leaf is then inserted for example down or along the full length of the core element), such that its gas/liquid channel opens out into the hollow which is designed to create the conduit or it opens out to a volume immediately above or near to the hollow which is designed to create the conduit. During the insertion, the electrode of the leaf may be conductively attached to the busbar associated with the hollow. For example, the electrode may become wedged against the busbar or the electrode may be welded, soldered, glued with a conductive glue, or otherwise conductively attached to the busbar, down part or all, of its length. The hollow containing the end of the inserted leaf and the associated busbar, is then filled with as potting; resin down its full length. The potting resin may be a conductive resin, or it may be a non-conductive resin in the case where the electrode has already been conductively attached to the busbar. The potting resin is then allowed to cure. Preferably but not exclusively, the thereby sealed resin-filled hollow is then drilled out using a suitable (larger diameter) drill bit capable of traversing the entire length of the resin-filled hollow, whilst making sure that the drill bit does not come near to the busbar associated with the hollow. In so doing, the sealed end of the gas/liquid channel of the leaf that is located within the hollow, is opened up to, and placed in unobstructed liquid/gas communication with the conduit that is created by the action of the drill bit. The hole down the full length of the resin-filled hollow, thereby creates a conduit which incorporates the open end of the gas/liquid channel of the leaf. In this way, the conduit is brought into fluid communication with the gas/liquid channels within the leaf. Moreover, electrical contact between the electrode of the leaf and the busbar is securely established.

Preferably but not exclusively, once the gas/liquid plumbing and the electrical attachments are secured, the lipped or flanged aperture on the external surface of the core element (into which the leaf has been inserted), is sealed by applying and curing a suitable, robust resin. In another embodiment, the aperture may be closed by interlocking (snapping) in a plastic part along the length of the aperture and then sealing and/or gluing the plastic part in place. In other embodiments, the aperture may be sealed and/or glued with a suitable resin after which a plastic part is snapped in over the resin whilst the resin is still drying.

When electrically connecting, the flexible leaf through the core, this may be combined with plumbing the leaf through the cow using any of the aforementioned methods for attaching the gas/liquid channels in the flexible leaf/leafs to the gas/liquid conduit, namely: (i) Conduit and Central Unit Assembly Method, (ii) Direct Attachment Method, or (iii) Conduit Unit Assembly Method.

An embodiment illustrating the combination of the Internal Spiral Attachment method for electrical, connection with the Conduit Unit Assembly method for gas/liquid plumbing is provided in the Rolodex design example (Example 4a).

The following examples provide illustrative combinations of the Internal Spiral Attachment method for electrical connection with the Direct Attachment method for gas/liquid plumbing using the following designs: (i) Wedge-Glue Design, Potted Plumbed Design, Two-Leaf Conductive Potted Plumbed Design, and the Multi-Leaf Parted Plumbed Design (see Example 3).

### Example 6a

### Electrically Connecting Two Flexible Electrode Leafs through the Core Element Using the Internal Spiral Attachment Method (for Electrical Connection) and the Direct Attachment Method (for Gas Plumbing) using the Wedge-Glue Design

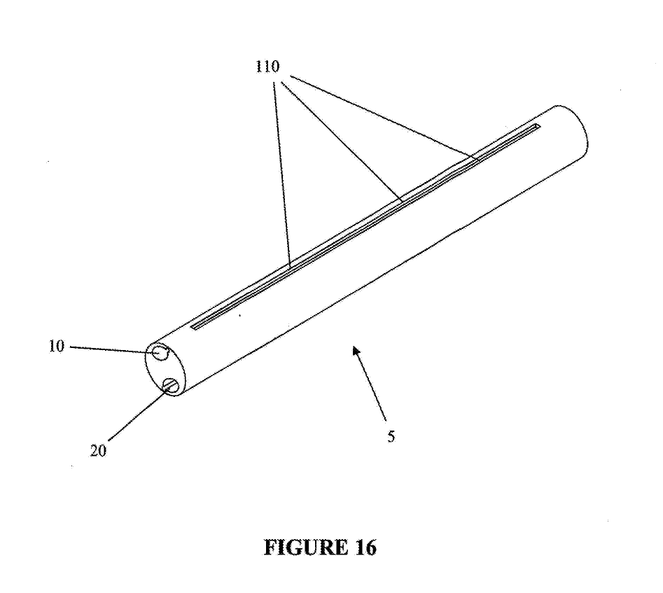

FIG. 16 schematically depicts an example core element 5, in the form of a central core element, showing two internal conduits 10 and 20 and the external, lipped or flanged aperture 110 of conduit 10 on the outer surface of the core element 5.

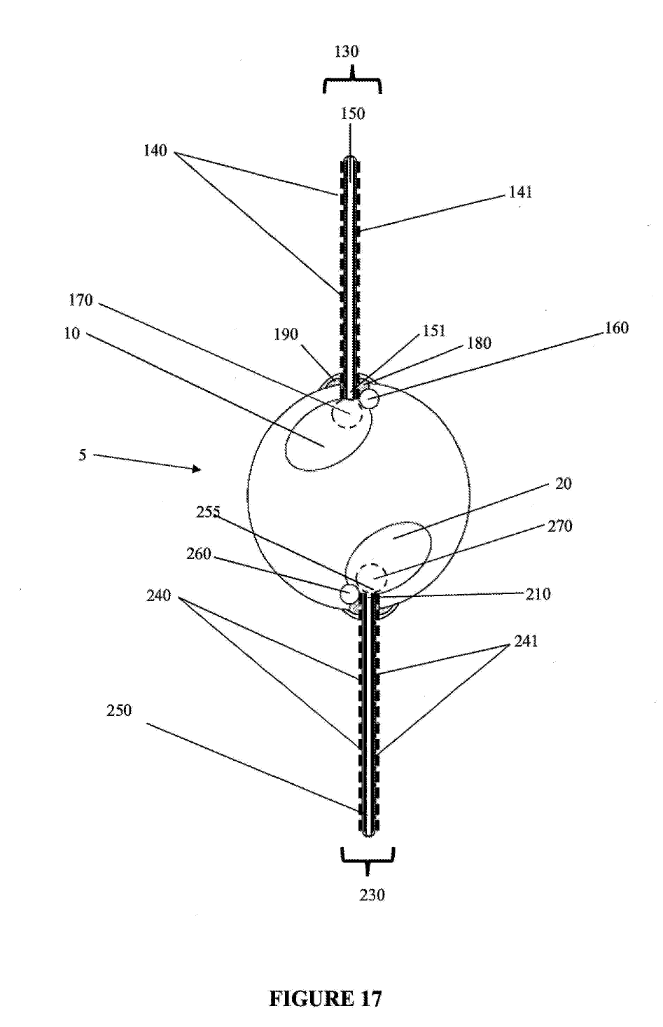

FIG. 17 schematically depicts the cross-section of an example core element 5 which can accommodate two leafs. As can be seen, the core element 5 contains two conduits (first conduit 10 and second conduit 20) along the length of the core element 5. The conduits 10, 20 are, in this case, elliptically shaped, opening up to an aperture near the outer surface of the core element. The conduits may have cross-sections of other geometries. At the aperture on the upper side of the core element 5, a leaf 130 has been inserted into and attached to conduit 10. The leaf contains over its outer surface, two sheet electrodes 140 and 141 (both of which are an anode for the cell). The center of the leaf comprises a sealed liquid/gas channel 150, which extends, sheet-like over the entire, or nearly entire, internal volume of the leaf. The bottom end or face of the gas channel 151 lies, along its full length, within the internal aperture of conduit 10, where leaf 130 and/or gas channel 151 has been glued in place using a conductive glue or resin 180 (which is depicted as the shaded area). This design for creating the gas plumbing is known as the “Wedge Glue” design.

In so doing, electrodes 141 and 140 have been electrically connected to an (anodic) busbar 160, which lies in a second tube extending or stretching the length of the core element 5, adjacent to, or near, the elliptical conduit 10. This method of electrically connecting the flexible electrode leaf is known as the “Internal Spiral Attachment” method. The busbar 160 is typically made of copper, but can be made of other metals or conductors.

A second, non-conductive resin or glue 190 has then been used to seal the outer connection between the leaf 130 and the core element 5. Thereafter, the region 170 has been drilled out through the full length of the core element 5, to thereby open the sealed, leaf gas/liquid channel 150 at end or face 151 to the gas/liquid conduit 10. This design for creating gas plumbing is known as the “Potted Plumbed” design. In the course of this procedure, the busbar 160 has been physically isolated from the other components in being surrounded and enclosed by the conductive resin 180 and non-conductive resin 190.

A similar situation pertains at the other conduit 20, where a second leaf 230, is illustrated about to be glued in place as shown in FIG. 17. The second leaf 230 comprises of a second, sheet-like sealed gas/liquid channel 250 bounded on its outer sides by two sheet electrodes 240 and 241. The electrodes are both cathodes for the cell. One end of the leaf 230 has been inserted into aperture 210, which contains a second (cathodic) busbar 260 immediately adjacent or near. The sheet electrodes 240 and 241 on the leaf will be glued into electrical contact with the busbar 260 using a conductive resin or glue. A non-conductive resin or glue will then be used to coat the outer connection between the leaf 230 and the core element and the area 270 will then be drilled out.

### Example 6b

### Electrically Connecting Eight Flexible Electrode Leafs through the Core Element Using the Internal Spiral Attachment Method (for Electrical Connection) and the Direct Attachment Method for Gas Plumbing) using the Wedge-Glue Design

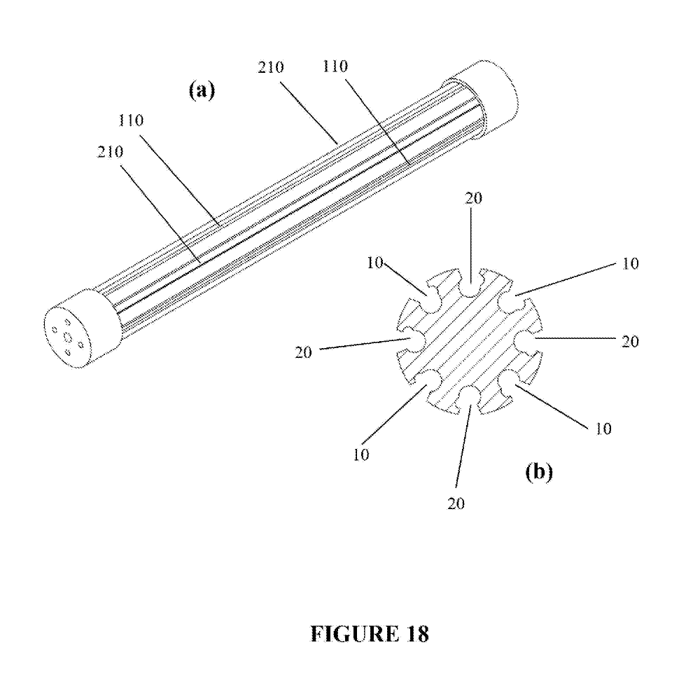

FIG. 18 schematically depicts a core element that is designed to accommodate 8 leafs. As can be seen in the cross-section shown on the bottom right of FIG. 18, there are 4 conduits 10 for attachment of anode-electrode leafs and 4 conduits 20 for attachment of cathode-electrode leafs. The upper image schematically depicts the outer appearance of the core element, with alternately-spaced lipped apertures 110 (for anode leafs) and 210 (for cathode leafs).

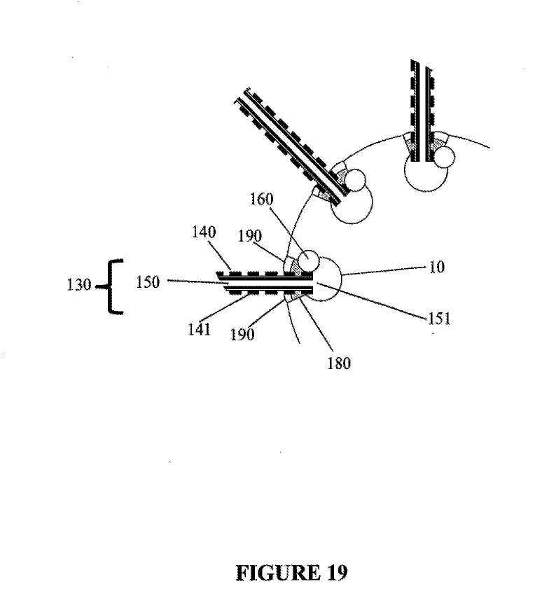

FIG. 19 shows how the leafs are attached to their respective conduits. One of the anode leafs 130 and its components are shown in the same numbered format as the previous example, attached to conduit 10.

### Example 6c

### Electrically Connecting Four Flexible Electrode Leafs through the Core Element Using the internal Spiral Attachment Method (for Electrical Connection) and the Direct Attachment Method (for Gas Plumbing) using the Wedge-Glue Design

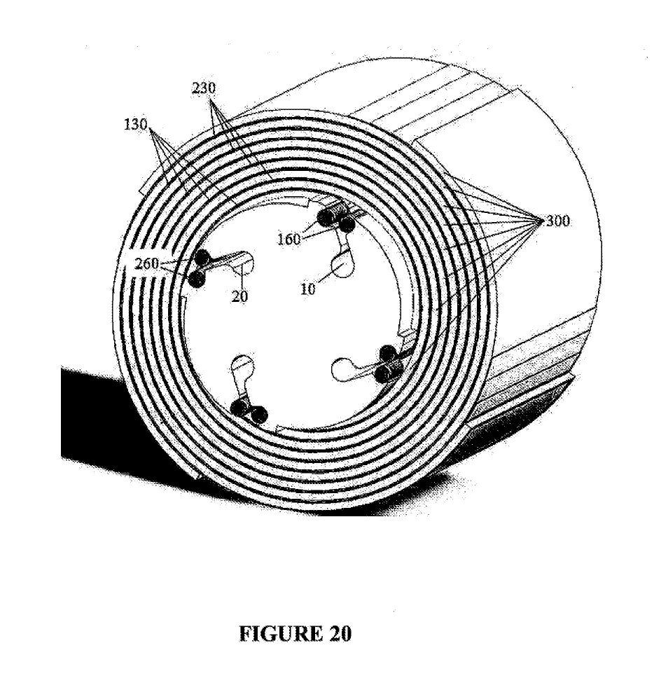

FIG. 20 schematically depicts a core element that is designed to accommodate 4 leafs with the four leafs spiral-wound around the core unit. As can be seen, there are 4 conduits in the core element. In cross-section, each conduit is teardrop shaped, with two busbars (shown as the rods 160 or 260) at the mouth of each conduit. For clarity, the resin glue areas on not shown in FIG. 20. The anode leafs 130 and the cathode leafs 230 are spiral wound around the core element, with suitable spacers 300 between the anode and cathode leafs to thereby prevent short-circuits.

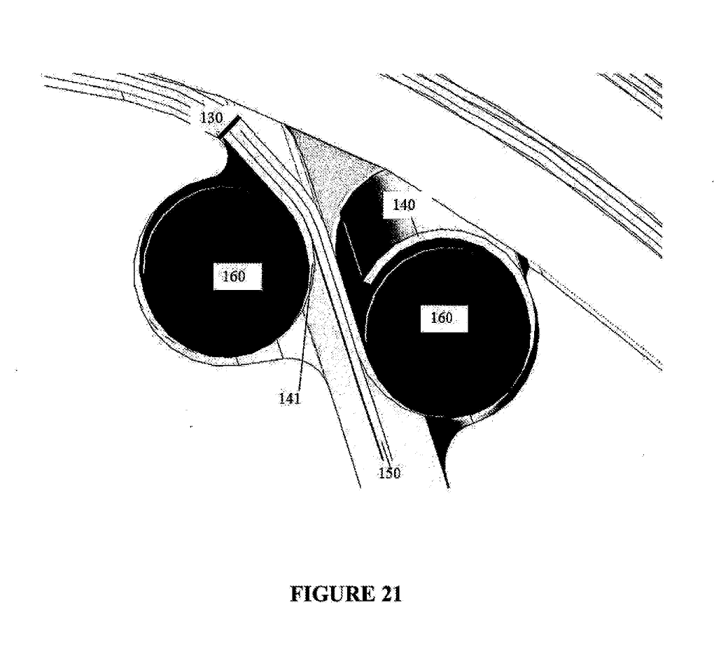

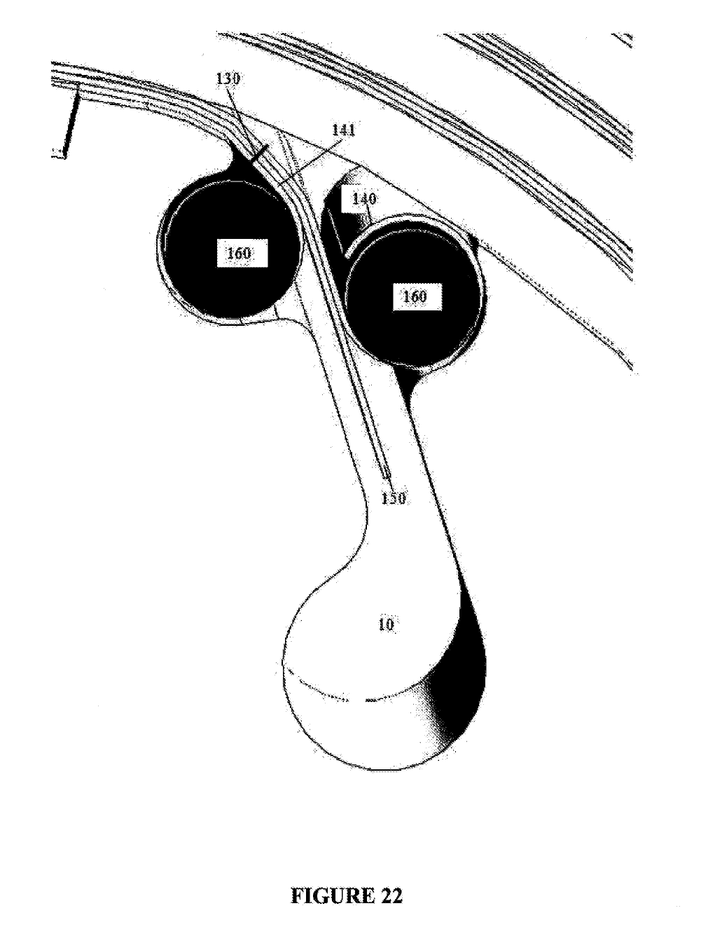

FIGS. 21 and 22 depict close-up views of the conduit 10 without the glued resins present (excluded for clarity). As can be seen, sheet electrodes 140 and 141 wind around and are wedged in close physical and electrical contact with the busbars 160, while the internal, sheet-like sealed liquid/gas channel 150 proceeds further down, where it is opened and in liquid/gas communication with the inner tear-drop shaped cavity 10.

### Example 6d

### Electrically Connecting Two Flexible Electrode Leafs through the Core Element Using the internal Spiral Attachment Method (for Electrical Connection) and the Direct Attachment Method (for Gas Plumbing) using the: (i) Potted Plumbed Design, (ii) Two-Leaf Conductive Potted Plumbed Design, and (iii) Multi-Leaf Conductive Potted Plumbed Design

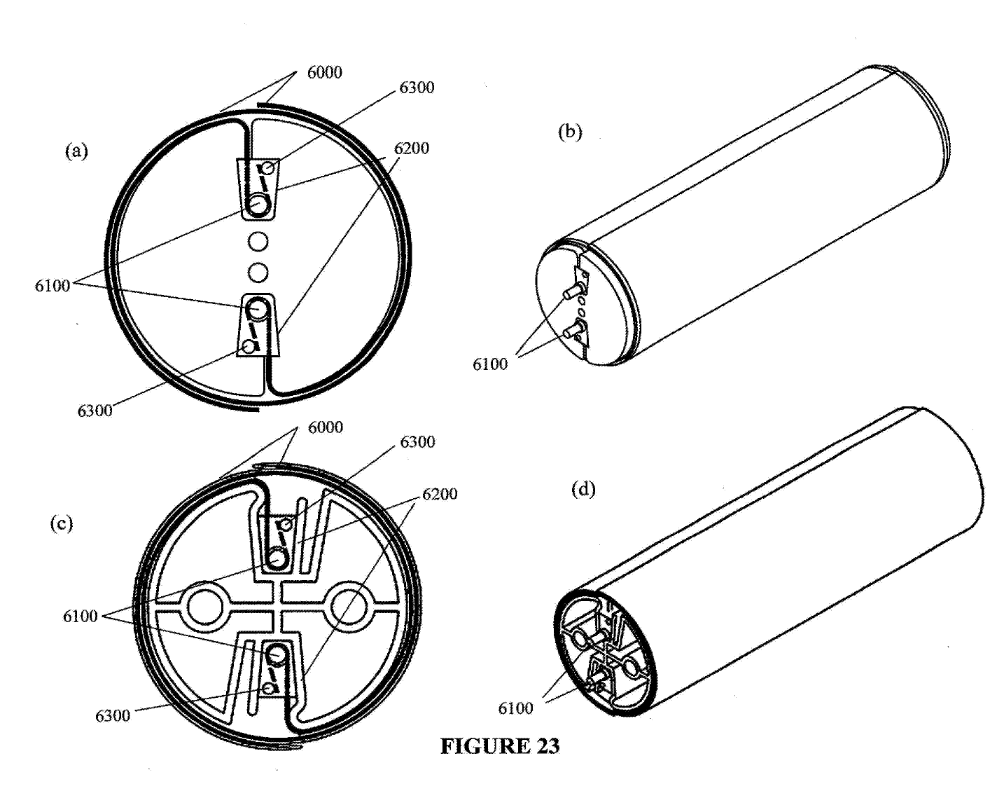

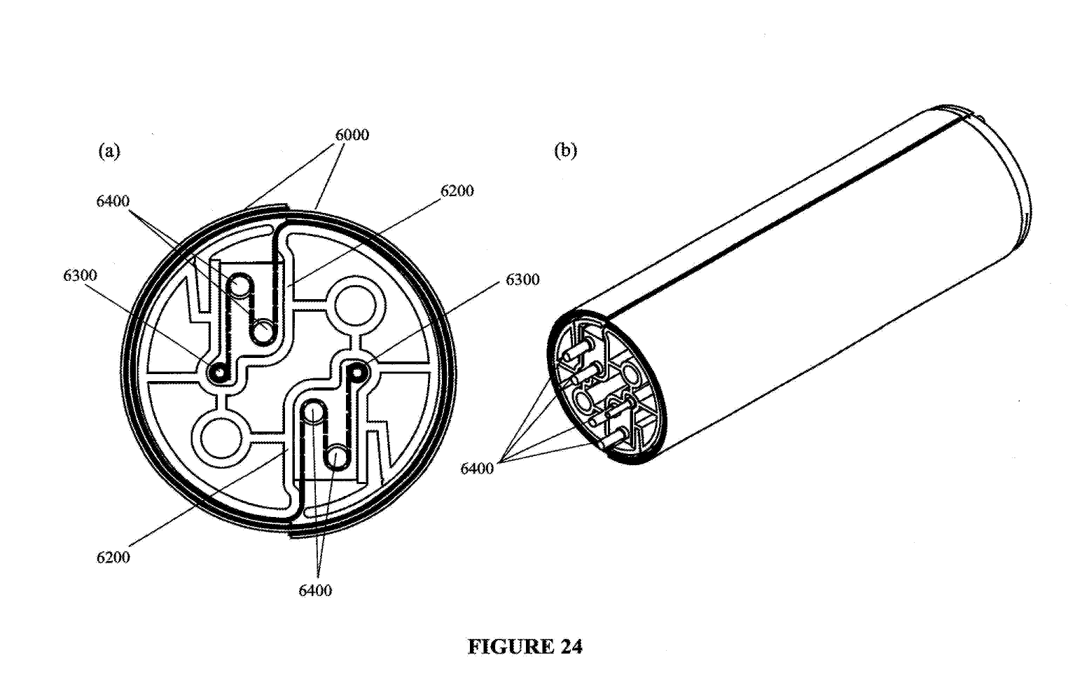

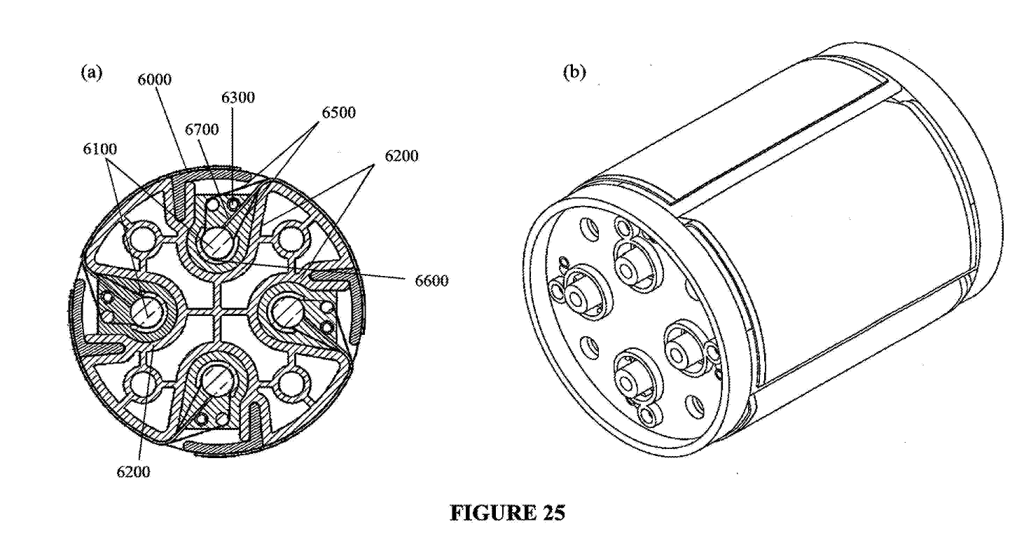

FIG. 23, FIG. 24, and FIG. 25 depict cross-sections and perspective views of core elements in which flexible electrode leafs 6000 have been electrically connected to primary busbars 6100 that run along the length of the core element.

FIG. 23 depicts two-leafed designs, in which each flexible leaf has been wound around a busbar 6100 that is located within a hollow 6200 in the core element. The electrode in the flexible leaf is thereby brought into conductive electrical contact with the busbar 6100. The hollow 6200 is then filled with potting resin which is allowed to cure. After the potting resin is cured, a drill is used to drill out a plumbing conduit at 6300, along the length of the potting resin to thereby create a gas/liquid plumbing conduit into which the internal channel of the leaf opens. By these means, the flexible leaf is plumbed into the conduit 6300 and placed in conductive electrical contact with the busbar 6100. This design is referred to as “Potted Plumbed” in general and “Conductive Potted Plumbed” when an electrically conductive potting resin has been used.

FIG. 24 depicts a similar design in which each leaf is wound around two primary busbars 6400. The intention here is to cater for a flexible leaf in which both sides are conductive and need to be electrically connected to a busbar. The two busbars 6400 in each potting hollow 6200 connect with the two conductive sides of the leaf. In this case, a conductive potting resin has been used to fill each hollow 6200.

FIG. 25 depicts a 4-leaf variant of FIG. 24, in which a single busbar 6100 has been located in each potting hollow 6200. The electrodes on each side of the flexible leaf 6500 have then been separated and wound from opposite sides around the busbar, with a conducting busbar clip 6600 holding them tights against the busbar 6100. The hollow 6200 has then been potted with conductive resin. After curing, a conduit 6300 is drilled out along the length of potting, thereby opening the gas/liquid channel 6700 of the leaf into the conduit. In this way, four leafs have been plumbed into four conduits 6300, with four primary busbars 61(X) providing electrical connection to both sides of each flexible leaf.

### Example 7

### Electrical Connection through the Core Element Using the Internal Spiral Busbar Attachment Method

The “internal Spiral Busbar Attachment” method is very similar to the “Internal Spiral Attachment” Method. It differs my in that one or More secondary busbars, disposed, lengthwise along the direction of spiral winding, are affixed in conductive contact to the flexible electrode. The secondary busbars are then attached, in conductive contact, to the (primary) busbar located in the core element.

In other words, the Internal Spiral Busbar Attachment method differs from the Internal Spiral Attachment method only in that one or more secondary busbars are interposed, electrically, between the flexible electrode and the primary busbar located in the core element. Depending on the size of the electrodes in be flexible leaf/leafs, it may be necessary to interpose secondary busbars between the primary busbar in the core element and the flexible electrode leafs in order to evenly distribute current over the flexible electrode leafs.

The Internal Spiral Busbar Attachment method therefore differs from the Internal Spiral Attachment Method only in that it interposes one or more secondary busbars between the primary busbar in the core element and the electrodes in the flexible leafs. In all other respects, the methods are the same.

### Example 8

### External Electrical Connection Using the External Spiral Attachment Method

Another variant on the Internal Spiral Attachment method is the External Spiral Attachment method, which differs only in that the primary busbar is located in the external element rather than in the core element.

Thus, there is provided a convenient and efficient configuration, arrangement, or design for an external element of spiral-wound electrochemical cells, modules or reactors. Such that the external element is fabricated to incorporate at least one busbar (a ‘primary’ busbar) down its length for a flexible leaf of the multi-electrode array, and where the flexible leaf comprises of a sealed gas/liquid channel with its associated electrode or electrodes.

In another embodiment, the external element includes a conducting element provided lengthways along the external element. The conducting element may be a conducting or metallic wire, tube, strip, rod or the like. In one example, the conducting element is a busbar. In another embodiment, the flexible electrode is in electrical contact with the conducting element. Preferably, the flexible electrode is welded, soldered, glued with conducting glue, or otherwise conductively attached to the conducting element in the external element.

The busbar can be positioned in an internal channel of the external element. Preferably, the busbar is a rod or wire of conductive material or metal. A conductive glue or resin can be used to electrically connect the flexible electrode to the busbar. An outer conductive surface of the flexible electrode can abut and electrically connect to the busbar. A non-conductive glue or resin can be used to attach the flexible electrode to the external element, with conductive attachment of the flexible electrode to the busbar achieved by welding, soldering, gluing with conducting glue, or otherwise conductively attaching them.

Optionally, the external element may contain multiple busbars, each insulated from each other, and each welded, soldered, glued with a conductive glue, or otherwise conductively attached to a different electrode—either anode or cathode—in the flexible electrode array. Optionally, the multiple busbars in the external element may each be conductively attached to the electrodes that form a different gas/liquid channel in the flexible electrode array.

In another aspect there is provided an external element for a spiral-wound electrochemical cell, the external element comprising: a conductive element associated with and located partly within at least one liquid/gas conduit provided lengthways along the external element; and, an aperture provided lengthways along the external element and associated with the at least one conduit and associated busbar; wherein, the aperture is able to receive an end from, or part of an end from, or gas from or liquid from a flexible electrode, and where the inserted flexible electrode may be simultaneously welded to, soldered to, or otherwise securely attached in conductive electrical contact with the busbar, where the flexible electrode is able to be spiral-wound around a separate core element.

In another embodiment, the aperture is able to provide a lip to, or part of a lip to, or gas to, or liquid to a flexible electrode, where the flexible electrode is able to be spiral-wound about a separate core element, while the inserted flexible electrode is simultaneously welded to, soldered to, glued to using conductive glue, or otherwise securely attached in conductive electrical contact with the associated busbar.

The flexible electrode may be securely wedged in the aperture in electrical contact with the busbar during an insertion process. Additionally or alternatively the flexible electrode may be welded or soldered or glued using conductive glue or otherwise electrically attached to the busbar. An example flexible electrode is a leaf having two conductive surfaces, layers or sheets on opposite faces of the flexible electrode.

In various examples the at least one conduit is a passageway, cavity or channel along an internal length of the external element. The at least one conduit can have an ellipsoidal or tear-drop shaped cross-section. The at least one conduit provides a gas or liquid communication channel. The external element can be fabricated from a polymeric material. Optionally, the aperture is lipped or flanged. Preferably, the aperture is located on an external surface of the external element. Optionally, the aperture or series of apertures is/are provided lengthways along part of the length of the external element. Alternatively, the aperture is provided lengthways along the full length of the external element.

The external element may include two, four, six, eight or more conduits and two, four, six, eight or more apertures and be able to receive two, four, six, eight or more flexible electrodes. An insulating flexible spacer is positioned adjacent an electrode and the flexible electrode and the insulating flexible spacer are spiral-wound about a separate core element, with the external element then left on the outside of the spiral-wound arrangement. The core element, spiral-wound electrode, and external element can be enclosed in a case or housing. The external element may form part or all of that case or housing.

Preferably but not exclusively, the leaf is inserted into the lipped or flanged aperture, causing the flexible electrode in the leaf to physically contact a busbar located down the length of the external unit within the conduit. In one embodiment, the flexible electrode may be made to become securely wedged in intimate contact with the busbar during the insertion process. In an alternative embodiment, the flexible electrode may be welded or soldered or otherwise securely attached in electrical contact to the busbar down or along the length of the flexible electrode, which may be the full length, before both the busbar and the attached leaf are inserted into the conduit.

Preferably but not exclusively, once the leaf electrode and the busbar are within the conduit and electrically connected to each other, then the connection between the electrode and the busbar are coated with an electrically conductive resin, down or along the length of the conduit, which may be the full length.

In this way, the electrode(s) in the leaf become(s) securely and electrically connected to the busbar in the external element, down or along the length of the external element, which may be the full length of the electrochemical module, reactor, or cell.

In another set of embodiments that involve apertures, which may optionally be lipped or flanged, the external element may contain a hollow, substantially hollow, or somewhat hollow cylinder-like structure all or part of the way down its length, where the conduits are designed to be created within the hollow, substantially hollow, or somewhat hollow portions of the cylinder-like structure. The hollow may have associated with it, a conductive element, which may be a busbar down its length, either fully or partly. Alternatively, a conductive element, which may be a busbar, may be introduced into the hollow. The leaf is then inserted (for example down or along the full length of the external element), such that its gas/liquid channel opens out into the hollow which is designed to create the conduit or it opens out to a volume immediately above or near to the hollow which is designed to create the conduit. During the insertion, the electrode of the leaf may be conductively attached to the busbar associated with the hollow. For example, the electrode may become wedged against the busbar, or the electrode may be welded, soldered, glued with conductive glue, or otherwise conductively attached to the busbar, down part or all of its length. The hollow containing the end of the inserted leaf and the associated busbar, is then filled with a potting resin down its full length. The potting resin may be a conductive resin, or it may be a non-conductive resin in the case where the electrode has already been conductively attached to the busbar. The potting resin is then allowed to cure. Preferably but not exclusively, the thereby sealed resin-filled hollow is then drilled out using a suitable drill bit capable of traversing the entire length of the resin-filled hollow, whilst making sure that the drill bit does not come near to the busbar associated with the hollow. In so doing, the sealed end of the gas/liquid channel of the leaf that is located within the hollow, is opened up to, and placed in unobstructed liquid/gas communication with the conduit that is created by the action of the drill bit. The hole down the full length of the resin-filled hollow, thereby creates a conduit which incorporates the open end of the gas/liquid channel of the leaf. In this way, the conduit is brought into fluid communication with the gas/liquid channels within the leaf. Moreover, electrical contact between the electrode of the leaf and the busbar is securely established.

Preferably but not exclusively, once the gas/liquid plumbing and the electrical attachments are secured, the lipped or flanged aperture on the external surface of the external element (into which the leaf has been inserted), is sealed by applying and curing a suitable, robust resin. In another embodiment, the aperture may be closed by snapping in a plastic part along the length of the aperture and then sealing and/or gluing the plastic part in place. In other embodiments, the aperture may be sealed and/or glued with a suitable resin after which a plastic part is snapped in over the resin whilst the resin is still drying.

### Example 9

### External Electrical Connection Using the External Spiral Busbar Attachment Method

The “External Spiral Busbar Attachment” method is very similar to the “External Spiral Attachment” Method. It differs only in that one or more secondary busbars, disposed lengthwise along the direction of spiral winding, are affixed in conductive contact to the flexible electrode. The secondary busbars are then attached, in conductive contact to the (primary) busbar located in the external element.

In other words, the External Spiral Busbar Attachment method differs from the External Spiral Attachment method only in that one or more secondary busbars are interposed, electrically, between the flexible electrode and the primary busbar located in the external element. Depending on the size of the electrodes in the flexible leaf/leafs, it may be necessary to interpose secondary busbars between the primary busbar in the external element and the flexible electrode leafs in order to evenly distribute current over the flexible electrode leafs.

The External Spiral Busbar Attachment method therefore differs from the External Spiral Attachment Method only in that it interposes one or more secondary busbars between the primary busbar in the external clement and the electrodes in the flexible leafs. In all other respects, the methods are the same.

### Example 10

### Gas/Liquid Plumbing through an End Cap Using the End Cap Conduit Method

In the following example, we describe the method of plumbing a spiral-wound module referred to above as the “End Cap Conduit” Method. In this method, preferably but not exclusively, the conduit is fabricated within a stand-alone end cap unit, to which one end of the flexible leaf is sealed, glued, welded, or otherwise attached in such a way that the aperture/s of the conduit is/are in fluid communication with the gas/liquid channels within the leaf.

Preferably but not exclusively, the portion of the stand-alone end cap that contains the conduit is spiral shaped, or capable of adopting a spiral shape, for example being bent into a spiral shape. Preferably but not exclusively, the aperture associated with the conduit has a u-shaped, an ellipsoidal or a tear-drop shaped cross-section to thereby facilitate sealing, gluing, or attachment by other means to a flexible electrode leaf that has been spirally-wound.

Preferably, one end of a flexible leaf that is open to the gas/liquid channel within the leaf, is located along the full length of the aperture of the conduit and then sealed, glued, or otherwise attached to the end cap. An insulating flexible spacer is then positioned adjacent to the electrode and the flexible electrode and the insulating flexible spacer are spiral-wound, causing the conduit in the end cap to adopt a spiral arrangement. If the conduit is already spiral shaped, then the act of feeding the leaf into the conduit aperture will create the spiral-winding. The end cap may optionally include two, four, six, eight or more conduits and two, four, six, eight or more apertures and be able to receive two, four six, eight or more flexible electrodes.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A spiral-wound electrochemical cell for forming a chemical reaction product, comprising at least one electrode pair wound about a central axis, wherein the at least one electrode pair is an anode and a cathode.

2. The electrochemical cell of claim 1, wherein the anode is gas permeable and liquid impermeable.

3. The electrochemical cell of claim 1 or 2, wherein the electrochemical cell is an electro-synthetic cell or an electro-energy cell.

4. The electrochemical cell of any one of claims 1 to 3, wherein the cell utilizes abiological manufactured components.

5. The electrochemical cell of claim 1, wherein:
the anode comprises a gas diffusion electrode; and/or
the cathode comprises a gas diffusion electrode;
and wherein, the gas diffusion electrode comprises substantially of carbon and/or polytetrafluoroethylene (PTFE).

6. The electrochemical cell of claim 1, further comprising an inter-electrode channel between the anode and the cathode for gas and/or fluid transport.

7. The electrochemical cell of any one of claims 1 to 6, further comprising two anodes and an anode channel between the two anodes for gas and/or fluid transport.

8. The electrochemical cell of any one of claims 1 to 7, further comprising two cathodes and a cathode channel between the two cathodes for gas and/or fluid transport.

9. The electrochemical cell of any one of claims 6 to 8, wherein the channel is at least partially formed by at least one spacer.

10. The electrochemical cell of any one of claims 1 to 6, further comprising at least two anodes and at least one anode channel, and at least two cathodes and at least one cathode channel.

11. The electrochemical cell of any one of claims 6 to 8, wherein the chemical reaction product is transported through the channel.

12. The electrochemical cell of any one of claims 6 to 8, wherein a chemical reactant is transported through the channel.

13. The electrochemical cell of claim 7, wherein the chemical reaction product is formed at, or a reactant is reacted at, the anodes and the product or reactant is transported through the anode channel.

14. The electrochemical cell of claim 8, wherein the chemical reaction product is formed at or a reactant is reacted at, the cathodes and the product or reactant is transported through the cathode channel.

15. The electrochemical cell of claim 6, wherein a liquid electrolyte is transported through the inter-electrode channel.

16. The electrochemical cell of claim 1, further comprising an anode leaf including an anode channel, and/or a cathode leaf including a cathode channel, and wherein an inter-electrode, channel is provided between the anode leaf and the cathode leaf, and wherein the leafs and the channels are spiral-wound about the central axis.

17. The electrochemical cell of claim 16, including a plurality of anode leafs, a plurality of cathode leafs, and a plurality of inter-electrode channels.

18. The electrochemical cell of any one of claims 1 to 17, further comprising a core element positioned at or about the central axis.

19. The electrochemical cell of claims 16 and 18, wherein the anode leaf and the cathode leaf are attached to the core element at different circumferential positions of the core element.

20. The electrochemical cell of claims 17 and 18, wherein the plurality of anode leafs and the plurality of cathode leafs are attached to the core element at different circumferential positions.

21. The electrochemical cell of claim 18, wherein the core element includes at least one gas channel and/or at least one fluid channel.

22. The electrochemical cell of claim 21, wherein the at least one gas channel is off-center of the core element.

23. The electrochemical cell of claim 21, wherein the at least one fluid channel is off-center of the core element.

24. The electrochemical cell of claims 6 and 21, wherein the inter-electrode channel is in gas communication and/or fluid communication with the core element.

25. The electrochemical cell of any one of claims 18 to 24, wherein one or more of the at least one electrode pair is electrically connected to a conducting element of the core element.

26. The electrochemical cell of any one of claims 1 to 25, further comprising an external element positioned away from the central axis.

27. The electrochemical cell of claim 26, wherein the external element is attached to or near an end of one or more of the at least one electrode pair, which is opposite to an end near the central axis.

28. The electrochemical cell of claims 6 and 26, wherein the inter-electrode channel is in gas communication and/or fluid communication with the external element.

29. The electrochemical cell of any one of claims 26 to 28, wherein one or more of the at least one electrode pair is electrically connected to a conducting element of the external element.

30. The electrochemical cell of claim 18, wherein the core element extends longitudinally parallel to the central axis.

31. The electrochemical cell of claim 26, wherein the external element extends longitudinally parallel to the central axis.

32. The electrochemical cell of any one of claims 1 to 31, further comprising at least one end cap.

33. The electrochemical cell of claims 16 and 32, wherein the anode channel, the cathode channel and/or the inter-electrode channel is in gas communication and/or fluid communication with the at least one end cap.

34. The electrochemical cell of claim 33, comprising a second end cap, the anode channel, the cathode channel and/or the inter-electrode channel in gas communication and/or fluid communication with the second end cap.

35. The electrochemical cell of claim 32, wherein one or more of the at least one electrode pair are electrically connected to a conducting element of the at least one end cap.

36. The electrochemical cell of any one of claim 25, 29 or 35, wherein the conducting element is a busbar.

37. The electrochemical cell of any one of claims 1 to 36, wherein one or more secondary busbars are electrically connected to one or more of the at least one electrode pair.

38. The electrochemical cell of claims 36 and 37, wherein the one or more secondary busbars are electrically connected to the busbar.

39. The electrochemical cell, of claim 37, wherein the one or more secondary busbars are flexible and are spiral-wound in the cell.

40. The electrochemical cell of claim 37, wherein the one or more secondary busbars extend in an axial direction of the cell.

41. The electrochemical cell of claim 2, wherein a wetting pressure or bubble point of the anode is in excess of 0.2 bar.
